(19) United States
(12) Patent Application Publication
(10) Pub. No.: US 2022/0351168 A1
(43) Pub. Date: Nov. 3, 2022

(54) PROCEDURE SHARING SYSTEM AND PROCEDURE SHARING METHOD

(71) Applicant: toraru co.,ltd., Hyogo (JP)

(72) Inventor: Jun NISHIGUCHI, Hyogo (JP)

(21) Appl. No.: 17/778,089

(22) PCT Filed: Jul. 22, 2020
(86) PCT No.: PCT/JP2020/028484

§ 371 Date: May 19, 2022

(30) Foreign Application Priority Data
Nov. 27, 2019 (JP) 2019-214410

(51) Int. Cl. G06Q 20/20; G06Q 20/32

(52) U.S. Cl. CPC G06Q 20/202; G06Q 20/3276

(57) ABSTRACT

A procedure sharing system and a procedure sharing method include a video information acquirer for acquiring video information at a first site at least including location information at the first site, identification information identifying the first site, and procedure information regarding a procedure at the first site, a video information deliverer for performing delivery to a second terminal at a second site in real time, a procedure information acquirer for acquiring the procedure information when the video information includes the procedure information, and a procedure information display for displaying the procedure information as the procedure information at the first site in a state where the procedure is allowed to be shared on the second terminal as the procedure information at the first site based on the location information and the identification information.

### TECHNICAL FIELD

The present invention relates to a procedure sharing system and a procedure sharing method in which terminals at a plurality of sites are communicatively connected over a network to share procedures between the respective sites.

### BACKGROUND ART

Conventionally, as a payment method that allows reducing a load of an input operation for making a payment and allows making a payment further quickly, for example, a payment method of Patent Document 1 and the like has been proposed,

The technique disclosed in Patent Document 1 focuses on the reduction in the load of the input operation when a user purchases a product, and provides the payment method that allows making a payment further quickly. Specifically, there are provided a first information terminal that possessed by a user, a retail store server that has a network to which the first information terminal is connected and stores product information including a product to be sold and its price, and a second information terminal including a camera unit connectable to the network.

The user causes the first information terminal to display a web page transmitted from the retail store server, and transmits purchase information, a user identifier, and the like to the retail store server based on the information on the web page. The retail store server calculates purchase money from the purchase information and the product information transmitted from the first information terminal, generates payment information including the purchase money, a payee, a product read from the purchase information, and the information of the user identifier with a two-dimensional code, and transmits it to the first information terminal.

The second information terminal photographs the two-dimensional code generated for each product purchase of the user displayed in the first information terminal by the camera unit, reads the payment information from the retrieved two-dimensional code, and transmits the read payment information to a payment agency server. By preliminarily using the two-dimensional code for each user regarding the product purchase, the user can reduce a load of an input operation in a shop, and can make a payment further quickly.
Patent Document 1: JP-A-2003-141433

### DISCLOSURE OF THE INVENTION

### Problems to be Solved by the Invention

In the system described in Patent Document 1 described above, the user needs to preliminarily confirm the information regarding the product that the user desires to purchase by the display in the retail store server, and input the information regarding the purchase. However, there is a concern of a variation, a shortage, and the like of the display, the description of the product, and description of a procedure of purchase or the like on the web page. Furthermore, the two-dimensional code dedicated for payment regarding the purchase product of the user generated by the retail store server needs to be displayed on the first information terminal of the user in a shop. However, for example, in the case of a product handled by an overseas shop, which is an actually far shop, the two-dimensional code cannot be displayed in a shop, and payment and another procedure by a user cannot be performed. Therefore, it is desired that even from a remote location, own favorite product information and a procedure, such as purchase, can be shared with an on-site shop in real time, and the procedure can be correctly performed in sensation as if the user were on the spot.

Therefore, the present invention has been invented in consideration of the above-described problems, and an object of the present invention is to provide a procedure sharing system and a procedure sharing method in which terminals at a plurality of sites are communicatively connected over a network and share procedures between the respective sites.

### Solutions to the Problems

A procedure sharing system according to a first invention in which terminals at a plurality of sites are communicatively connected over a network to share procedures between the respective sites includes: video information acquiring means, video information delivering means, procedure information acquiring means, and procedure information displaying means. The video information acquiring means acquires video information at a first site including location information at the first site, identification information identifying the first site, and procedure information regarding the procedure at the first site based on photographing request information regarding an instruction of photographing input by a first terminal at the first site via a second terminal at a second site between the first terminal at the first site and the second terminal at the second site preliminarily connected to the first terminal among the plurality of sites. The video information delivering means delivers the video information acquired by the video information acquiring means to the second terminal at the second site in real time. The procedure information acquiring means acquires the procedure information based on instruction information regarding the photographing of the procedure information input via the second terminal at the second site via the first terminal when the video information delivered by the video information delivering means includes the procedure information. The procedure formation displaying means displays the procedure information acquired by the procedure information acquiring means in a state where the procedure is allowed to be shared on the second terminal based on the location information, the identification information, and a display restriction at the second site or in the second terminal related to the procedure information.

A procedure sharing system according to a second invention, which is in the first invention, further includes a third terminal at the second site and procedure information performing means. The procedure information performing means acquires the procedure information displayed by the procedure information displaying means via the third terminal, discriminates a procedure performable by the third terminal at the second site based on the acquired procedure information, and performs the procedure information via the third terminal by the discriminated procedure.

In a procedure sharing system according to a third invention, which is in the first invention, the procedure information acquired by the video information acquiring means is displayed by non-disclosure, disclosure, or alternative display in the first terminal or the second terminal. The procedure information includes at least any information of object information identifying an object at the first site, procedure person information identifying a procedure person who performs the procedure, procedure location information identifying a procedure place, a procedure period information regarding a valid period of the procedure, and payment information regarding a payment for the procedure.

In a procedure sharing system according to a fourth invention, which is in the first invention, when the procedure information acquiring means acquires the procedure information included in the video information via the first terminal, the procedure information acquiring means acquires the procedure information as a still image such that the procedure information is not deployed in the first terminal or the second terminal.

In a procedure sharing system according to a fifth invention, which is in the third invention, the procedure information displaying means allows displaying the procedure information delivered by the video information delivering means by non-disclosure, disclosure, or alternative display in the first terminal or the second terminal. When a plurality of pieces of the procedure information are present, the plurality of pieces of procedure information are displayed in a state where the procedure is allowed to be shared on the second terminal as the procedure information at the first site based on at least any information of the object information, the procedure person information, the procedure location information, the procedure period information, and the payment information included in the procedure information.

A procedure sharing method according to a sixth invention in which terminals at a plurality of sites are communicatively connected over a network to share procedures between the respective sites executed by a computer includes: a video information acquiring step of acquiring video information at a first site including location information at the first site, identification information identifying the first site, and procedure information regarding the procedure at the first site based on request information regarding photographing at the first site input via a second terminal at a second site via a first terminal between the first terminal at the first site and the second terminal at the second site preliminarily connected to the first terminal among the plurality of sites; a video information delivering step of delivering the video information acquired at the video information acquiring step to the second terminal at the second site in real time; a procedure information acquiring step of acquiring the procedure information based on instruction information regarding the photographing of the procedure information input via the second terminal at the second site via the first terminal when the video information delivered at the video information delivering step includes the procedure information; and a procedure information displaying step of displaying the procedure information acquired at the procedure information acquiring step in a state where the procedure is allowed to be shared on the second terminal based on the location information, the identification information, and a display restriction at the second site or in the second terminal related to the procedure information,

In a procedure sharing method according to a seventh invention, which is in the sixth invention, on the third terminal at the second site, the computer performs a procedure information performing step of acquiring the procedure information displayed at the procedure information displaying step via the third terminal, the procedure information performing step of discriminating a procedure performable by the third terminal at the second site based on the acquired procedure information, the procedure information performing step of performing the procedure information via the third terminal by the discriminated procedure.

### Effects of the Invention

According to the first invention to the fifth invention, the video information acquiring means acquires the video information at the first site including the location information at the first site, the identification information identifying the first site, and the procedure information regarding the procedure at the first site between the first terminal at the first site and the second terminal at the second site. This allows sharing the video information between the sites, the first site and the second site. This allows correctly dealing with, for example, points to be checked and surrounding situations related to a request and a procedure of product purchase when the video information includes the procedure information.

Especially, according to the first invention, the video information delivering means delivers the video information acquired by the video information acquiring means to the second terminal at the second site. In view of this, at the second site, the video information at the first site can be acquired in real time. This allows correctly performing the procedure in sensation as if a person were on the spat.

Especially, according to the first invention, the procedure information acquiring means acquires the procedure information from the video information delivered by the video information delivering means. In view of this, only the information required for payment and a purchase procedure can be extracted. This allows performing the procedure at the first site at the second site based on the procedure information.

Especially, according to the first invention, the procedure information displaying means displays the procedure information acquired by the procedure information acquiring means in the state where the procedure can be performed on the second terminal. In view of this, only the information required for payment and purchase procedure can be displayed. This allows performing the procedure at the first site at the second site based on the procedure information at the first site.

Especially, according to the second invention, the procedure information performing means performs the procedure information as the procedure 1w the third terminal. In view of this, a payment, the purchase procedure, and the like can also be performed at a remote location. This allows performing the procedure at the first site by the third terminal.

Especially, according to the third invention, the procedure information includes at least any additional information of the object information identifying the object at the first site, the procedure person information identifying the procedure person who performs the procedure, the location information identifying a procedure place, the period information regarding a valid period of the procedure, and the payment information regarding the payment for the procedure. In view of this, a favorite product can be easily confirmed via the terminal of the executer who performs on-site photographing. Accordingly, payment of the product to be purchased can be made, and further, various procedures and the like regarding the product can be correctly performed.

Especially, according to the fourth invention, the procedure information acquiring means acquires the procedure information included in the video information acquired by the video information acquiring means as the still image. In view of this, the procedure information is not performed by the first terminal. Thus, the procedure information acquired at the first site can be displayed on the second terminal at the second site as is, and the procedure information at each site can be shared.

Especially, according to the fifth invention, the procedure information displaying means displays the plurality of pieces of procedure information in a state in which the procedure can be shared on the second terminal as the procedure information at the first site based on at least any information of the object information, the procedure person information, the procedure location information, the procedure period information, and the payment information included in the procedure information, in view of this, the plurality of pieces of procedure information can be identified. Accordingly, even when the procedure information is plural, based on the additional information identifying the procedure information, the plurality of pieces of procedure information can be displayed on the second terminal in the state where the procedure of each piece of the procedure information can be performed.

According to the sixth invention and the seventh invention, at the video information acquiring step, the video information including the location information at the first site, the identification information identifying the first site, and the procedure information regarding the procedure at the first site are acquired between the first terminal at the first site and the second terminal at the second site. This allows sharing the video information between the sites, the first site and the second site. This allows correctly dealing with, for example, the points to be checked and the surrounding situations related to the request and the procedure of product purchase when the video information includes the procedure information.

### BRIEF DESCRIPTION OF THE DRAWINGS

FIG. 1 is a schematic diagram illustrating an example of a procedure sharing system according to an embodiment.

FIG. 2 is a schematic diagram illustrating an example of sharing a procedure by a first terminal at a first site and a second terminal at a second site according to this embodiment.

FIG. 3 is a schematic diagram illustrating an example of sharing the procedure by the second terminal at the second site and a third terminal according to this embodiment.

FIG. 4 is a schematic diagram illustrating an example of a configuration of the procedure sharing system according to this embodiment.

FIG. 5 is a schematic diagram illustrating an example of a function of the procedure sharing system according to this embodiment.

FIG. 6A is a schematic diagram illustrating an example of an executer information data table stored in a management database according to this embodiment. FIG. 6B is a schematic diagram illustrating an example of a requestor information data table stored in the management database according to this embodiment. FIG. 6C is a schematic diagram illustrating an example of a procedure person information data table stored in the management database according to this embodiment.

FIG. 7A is a schematic diagram illustrating an example of a shop information data table stored in a procedure sharing database according to this embodiment. FIG. 7B is a schematic diagram illustrating an example of a procedure information data table stored in the procedure sharing database according to this embodiment. FIG. 7C is a schematic diagram illustrating an example of the procedure person information data table stored in the procedure sharing database according to this embodiment.

FIG. 8 is a schematic diagram depicting an example of a sequence of a procedure sharing process in an object, the first terminal, the second terminal, and the third terminal of the procedure sharing system according to this embodiment.

FIG. 9 is a schematic diagram illustrating a first modification of an operation of the procedure sharing system according to this embodiment.

FIG. 10 is a schematic diagram illustrating a second modification of an operation of the procedure sharing system according to this embodiment.

FIG. 11 is a schematic diagram illustrating a third modification of an operation of the procedure sharing system according to this embodiment.

FIG. 12 is a schematic diagram illustrating a fourth modification of an operation of the procedure sharing system according to this embodiment.

### DESCRIPTION OF PREFERRED EMBODIMENTS

The following will describe an example of a procedure sharing system and a procedure sharing method in an embodiment to which the present invention is applied with reference to the drawings.

### Embodiments: Procedure Sharing System 100

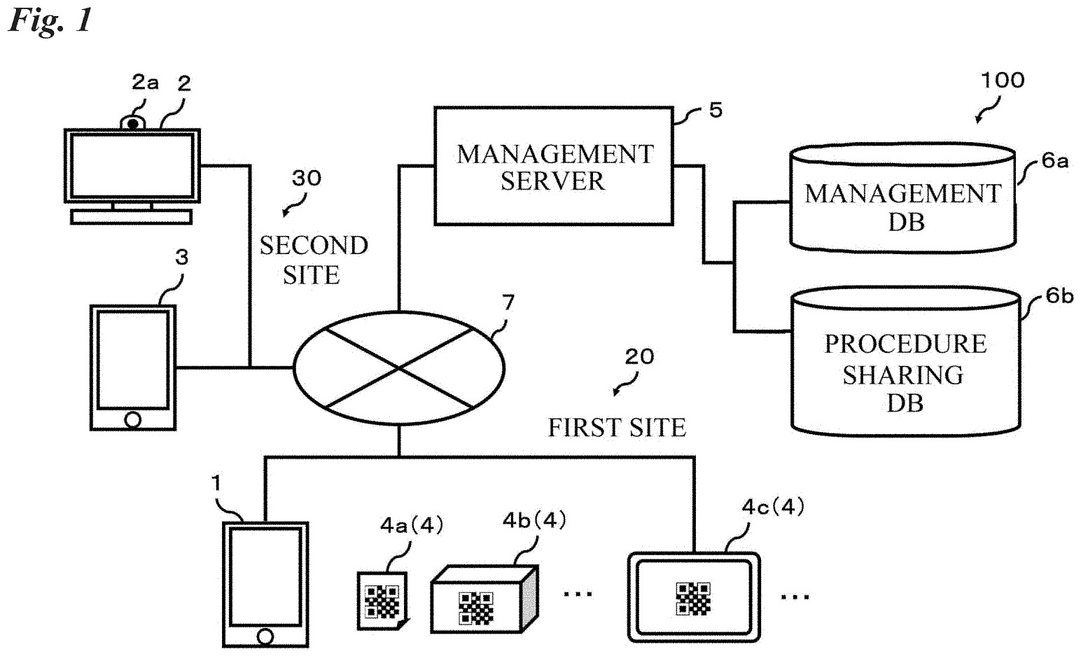

With reference to FIG. 1 to FIG. 7, an example of a configuration of a procedure sharing system 100 according to this embodiment that shares a procedure between a first terminal 1 at a first site 20, an object 4 (an object a, an object 4b, or an object 4c), a second terminal 2, at a second site 30, a camera 2a provided in the second terminal 2, a third terminal 3 and the like, and the sites will be described. FIG. 1 is a schematic diagram illustrating a whole configuration of the procedure sharing system 100 according to this embodiment.

The procedure sharing system 100 mainly connects the first terminal 1 at the (on-site) first site 20 and the second terminal 2 at the second site 30 (a remote location), acquires video information at the first site 20, and displays procedure information 10a shared with the second terminal 2 at the second site 30 in the video information on the second terminal 2 at the second site 30. The procedure sharing system 100 causes the second terminal 2 to display the procedure information 10a and causes the third terminal 3 to acquire the procedure information 10a to perform a procedure at the on-site first site 20 as a procedure by the third terminal 3 at the second site 30.

The procedure sharing system 100, for example, receives execution information regarding performing experience from the first terminal 1 of an executer at the on-site first site 20 and request information regarding a request of the experience from the second terminal 2 or the third terminal 3 of a requestor at the second site 30 as the remote location. The procedure sharing system 100, for example, may make determination based on information desired to be shared included in each of the received request information and execution information, and information, such as a place and a location desired to be shared, date and time and a period when the sharing is possible, and a compensation for each of them.

The procedure sharing system 100 may receive a condition regarding the experience shared via the first terminal 1 at the first site 20 and the second terminal 2 at the second site 30, for example, may register the condition for the experience shared between the respective first terminal 1 and second terminal 2 with a management database 6a. The procedure sharing system 100 may determine the respective terminals at the first site 20 and the second site 30 that share the experience by a result of matching of the condition for the experience registered and shared by the first terminal 1 and the second terminal 2. The procedure sharing system 100 performs, for example, as the procedure shared between the respective sites, for example, a payment procedure, a reservation procedure, a vicarious execution procedure, and an approval procedure.

The procedure sharing system 100 registers various procedures (flows) and the like, which are procedure processes of the respective terminals between the plurality of sites, as, for example, the procedure information (such as a two-dimensional code) pasted to or displayed on the predetermined object 4a or the like. After this registration process, the procedure sharing system 100, for example, delivers the video information acquired by the first terminal 1 at the first site 20 to the second terminal 2 at the second site 30 to ensure performing the process or the like regarding the on-site various procedures on another computer, such as the remote second terminal 2 and third terminal 3, at the remote location, such as the second site 30. For example, the procedure sharing system 100 instructs the executer of the first terminal 1 at the first site 20 to perform on-site photographing with photographing request information by the requestor input via the second terminal 2 at the second site 30 (the remote location).

The procedure sharing system 100, for example, may cause the first terminal 1 at the first site 20 to function as the second terminal 2 at the second site 30 or may cause the second terminal 2 at the second site 30 to function as the first terminal 1 at the first site 20. In this case, for example, the second terminal 2 at the second site 30 acquires the procedure information 10a displayed in the third terminal 3 by the camera 2a provided in the second terminal 2 and delivers it to the first terminal 1 at the first site 20. The first terminal 1, for example, displays the procedure information 10a of the third terminal 3. For example, the procedure information 10a displayed in the first terminal 1 may be read by a terminal of a shop at the first site 20 and the procedure may be performed.

The procedure sharing system 100 includes, for example, a management server 5 as illustrated in FIG. 1. The management server 5 includes the management database 6a and a procedure sharing database 6b. The management database 6a stores, for example, various kinds of information regarding the requestor at the remote location, various kinds of information regarding the executer who performs on-site photographing, and various kinds of data regarding the on-site shop. The procedure sharing database 6b stores information regarding various procedures shared by each person, such as the procedure information shared between the requestor and the executer, procedure information shared between the requestor and the shop, and the procedure information 10a performed for another agency by the requester.

Various kinds of information transmitted over, for example, a communication network 7 (a public communication network) is accumulated in the management database 6a and the procedure sharing database 6b. The management server 5, for example, manages the first terminal 1 at the first site 20, various posters and fliers, the object 4a pasted to, for example, a menu, an outer case of a product, a body of the product, the object 4b, a fourth terminal 4 and the second terminal 2 and the third terminal 3 at the second site 30, the management database 6a, the procedure sharing database 6b, and a procedure sharing application, and registers and updates each piece of information over the communication network 7.

<Management Server 5>

The management server 5 determines the terminals that can share the experience and the procedure between the first site and the second site based on, for example, respective conditions (for example, date and time, a place, the other party, a feature, a procedure, and a cost) input via the first terminal 1, the second terminal 2, or the third terminal 3. The management server 5, for example, may determine the details, such as experience of an event, date and time regarding a procedure or the like, a place, a purpose, and a cost, shared between members at respective sites via, for example, message exchange exchanged in an SNS, a chat, a community, or the like for the members of the procedure sharing system provided by the management server 5 (not illustrated).

The management server 5, for example, connects to the first terminal 1 at the first site 20 and the fourth terminal 4 or the like installed at a shop or the like over the communication network 7. Additionally, the management server 5, for example, connects to a plurality of the second terminals 2 and a plurality of the third terminals 3 at the second site 30 over the communication network 7.

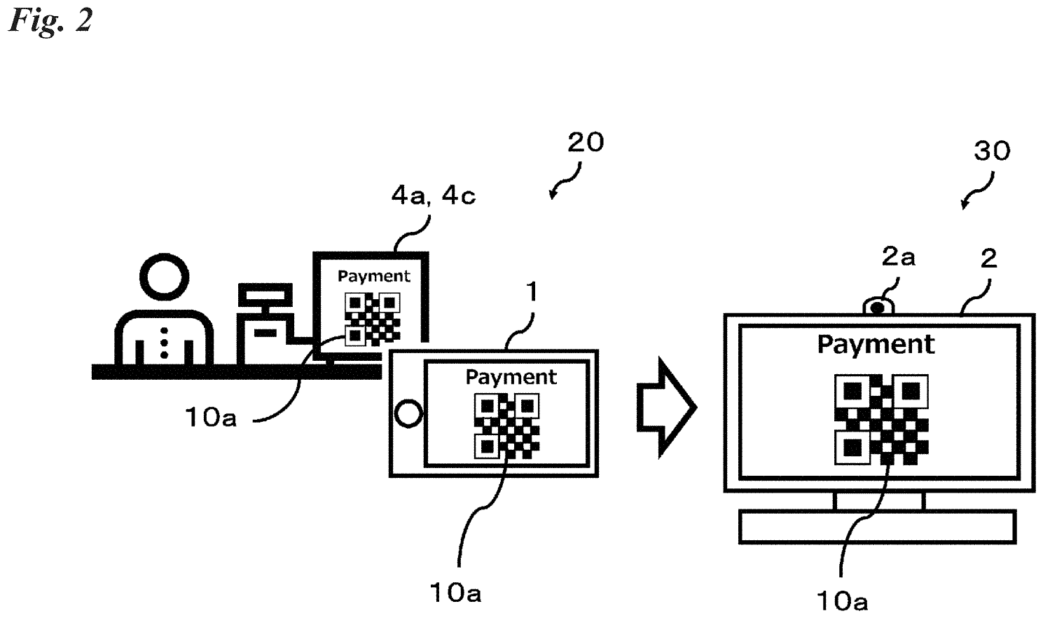

Here, with reference to FIG. 2, an example of sharing the procedure between the first terminal 1 at the first site 20 and the second terminal 2 at the second site 30 will be described. The first site 20 is, for example, a place and a spot physically away from the second site 30, and, for example, a shop and a counter inside a shop. The second site 30 is, for example, a place and a facility physically away from the first site 20, and, for example, may be an office and home.

For example, the objects 4a to 4c are installed to the counter in the shop at the first site 20. On the objects 4a to 4c, at least any information of, for example, detailed information and associated information of, for example, a product and a menu, and a link destination of a website on which they are recorded may be displayed as QR codes (registered trademark), and the objects 4a to 4c may be QR codes that record information (such as ‘PAY’ and ‘CANCEL’) regarding a procedure regarding a procedure to the shop (such as ‘PAY’) and electronic payment (such as ‘1000 yen’).

The object 4a, for example, may be a message board, in addition to, for example, a paper. The object 4c may be, for example, an electronic tablet possessed 1w the shop, and various kinds of information and procedures may be generated as, for example, a QR code by the known coding technique.

The various kinds of procedure information 10a displayed on the objects 4a to 4c are, for example, a QR code. The procedure information 10a is acquired by the first terminal 1 at the first site 20 and delivered to the management server 5, and besides, may be delivered to the second terminal 2 or the third terminal 3 connected to the first terminal 1.

The first terminal 1 acquires the procedure information 10a included in a video obtained by shooting of, for example, a scene, a mountain and a river, a town, a shop, an inside of a shop, or a product displayed in a shop, at the first site 20 and displayed on the objects 4a to 4c. The procedure information 10a acquired by the first terminal 1 may be delivered to the second terminal 2 at the second site 30 via, for example, the management server 5. Besides, the procedure information 10a may be, for example, directly delivered to the second terminal 2 at the second site 30 connected in real time.

The second terminal 2 at the second site 30 delivers the video information of the first site 20 to the second terminal 2 at the second site 30 via the management server 5 or from the connected first terminal 1 directly in real time. The management server 5 or the second terminal 2 at the second site 30, for example, may detect location information at the first site and identification information identifying the first site included in the video information imaged by the first terminal 1 at the first site 20 or each of an imaged distinctive scene, an image, a marker, a feature value, and the like, and may acquire it using, for example, a difference in a data amount between the detected feature information and, for example, the identification information of the objects 4a to 4c recorded in the management database 6a in advance.

For example, when the procedure information 10a is included, the second terminal 2 displays it as the procedure information 10a at the first site 20 in a state where the procedure can be shared as the procedure information 10a at the first site 20 on the second terminal 2 based on, for example, the location information and the identification information. In addition to acquiring the procedure information 10a in response to an instruction from, for example, the second terminal 2 or the third terminal 3, for example, the first terminal 1 may discriminate only a part of the procedure information 10a in the video information based on code information representing the procedure information 10a in the video information, and causes it to be enlarged and displayed on a screen of the second terminal 2 separately from the video information delivered in real time in the second terminal 2.

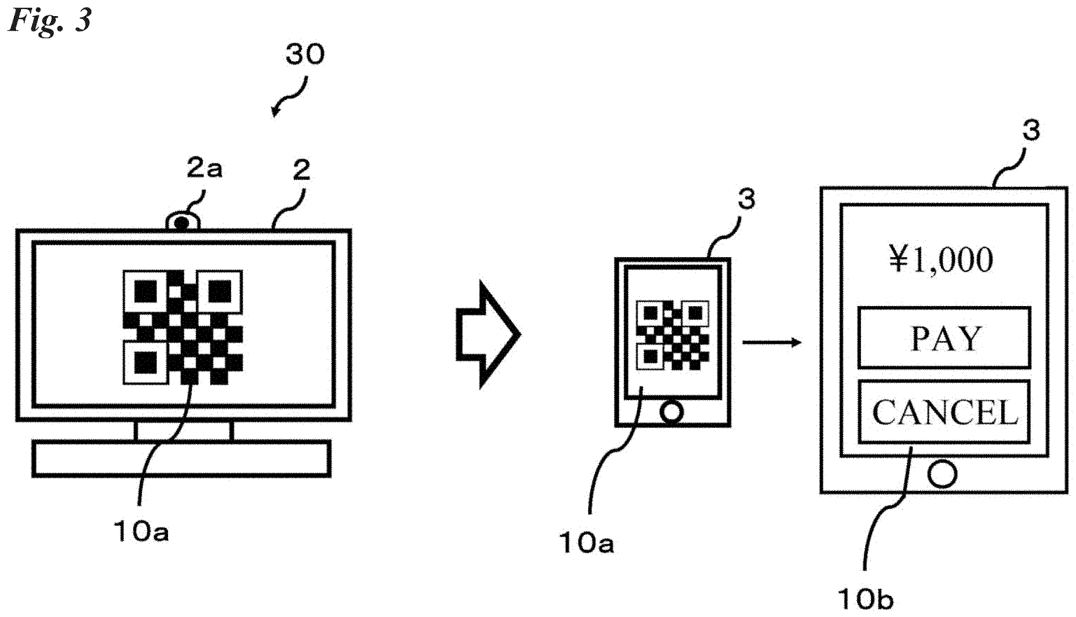

Next, with reference to FIG. 3, an example of sharing the procedure information 10a between the second terminal 2 and the third terminal 3 at the second site 30 according to this embodiment will be described. The second terminal 2 receives the delivery of video information acquired by the first terminal 1 at the first site 20 in real time. For example, when the procedure information 10a is included in it, the second terminal 2 displays the procedure information 10a on the screen of the second terminal 2 so as to ensure performing the procedure. The second terminal 2, for example, may acquire the procedure information 10a displayed in the video information delivered via the management server 5 or the first terminal 1 as a still image (capture). For example, the second terminal 2 may retrieve it by, for example, an image recognition application (not illustrated) provided in the second terminal 2, and may display it in a state of ensuring performing a procedure (display that can be processed in the third terminal 3).

The second terminal 2 and the third terminal 3, for example, shares the procedure of the procedure information 10a displayed on a monitor of the second terminal 2 at the second site 30. The third terminal 3, for example, may acquire the procedure information 10a displayed in the second terminal 2 using a camera (not illustrated) function provided in the third terminal 3. For example, a plurality of terminals (not illustrated) may be disposed at the second site 30 other than the third terminal 3, and acquire the procedure information 10a displayed in the second terminal 2.

For example, when the second site 30 is a living room inside a house, the procedure sharing system 100 allows sharing the procedure information 10a displayed in the second terminal 2 by respective users of the plurality of terminals via the display of the second terminal 2 installed in the living room. Each of the plurality of terminals, for example, performs a process with the procedure information 10b using the identification information of the terminal of each user to ensure sharing the procedure, such as a payment, easily with the first site 20.

Note that when the procedure information 10a, is for example, information limited to the user of the third terminal 3, the procedure may be a procedure that can be processed only by the third terminal 3, and when the first terminal 1 acquires the procedure information 10a at the first site 20, terminal information of an execution source may be added.

The third terminal 3, for example, discriminates the procedure information 10a acquired from the second terminal 2 by a procedure sharing application preliminarily provided by the management server 5. By performing the procedure information 10b discriminated by the procedure sharing application by the third terminal 3, the third terminal 3 performs, for example, the corresponding procedure on the management server 5, another server (not illustrated), or the like.

<Management Server 5>

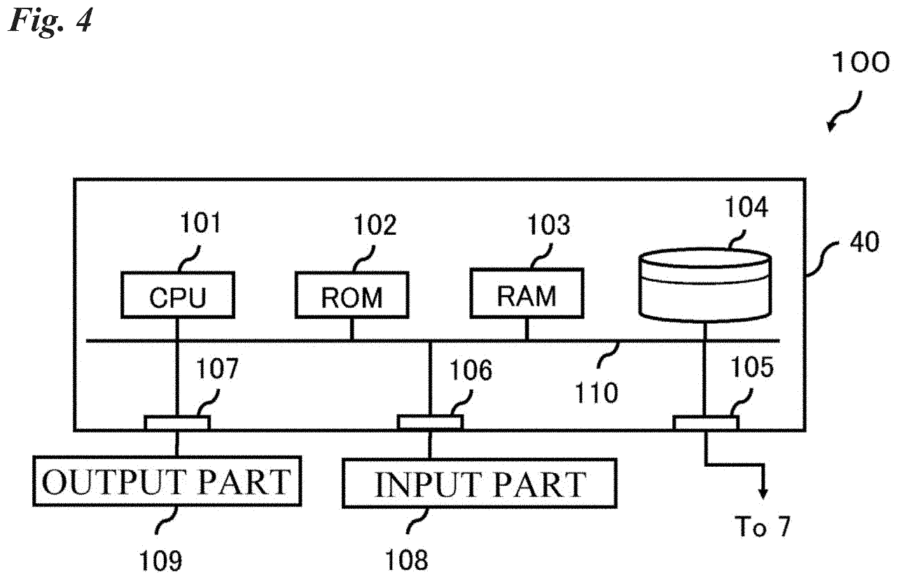

Next, with reference to FIG. 4, an example of a configuration of a procedure sharing system according to this embodiment will be described. FIG. 4 is a schematic diagram illustrating an example of a configuration of the management server 5 of the procedure sharing process according to this embodiment.

As the procedure sharing system 100, the management server 5, may have, for example, a configuration (not illustrated), such as a client server system and a cloud system, includes a housing 40, a Central Processing Unit (CPU) 101, a Read Only Memory (ROM) 102, a Random Access Memory (RAM) 103, a storage unit 104, and a respective plurality of 105 to 107, and each configuration is connected by an internal bus 110. The CPU 101 controls the whole management server 5. The ROM 102 stores an operation code of the CPU 101. The RAM 103 is a working area used during the operation of the CPU 101.

In addition to information regarding the requestor and the executer necessary to share the procedure, the storage unit 104 stores information, such as various kinds of information, such as location information of the first site 20 and the second site 30, information of various terminals, information regarding the requestor, the executer, and the procedure person of the procedure, identification information regarding the procedure shared at the respective sites, and a type and a condition of a specific sharing procedure. As the storage unit 104, for example, in addition to a Hard Disk Drive (HDD), a data storage device (not illustrated), such as, a Solid State Drive (SSD), a hard disk and a semiconductor memory, may be used.

The CPU 101 is achieved by executing a program stored in the storage unit 104 or the like with the RAM 103 as the working area. For example, the management server 5 may include a Graphics Processing Unit (GPU) (not illustrated). Including the GPU allows high-speed arithmetic processing than usual.

The I/F 105 is an interface to transmit and receive various kinds of information connected over the communication network 7. The I/F 105 transmits and receives various kinds of information between the terminals at a plurality of sites over the communication network 7. The I/F 106 an interface to transmit and receive the information with an input part 108. As the input part 108, for example, a keyboard is used. An administrator of the management server 5 transmits and receives various kinds of information, and inputs control commands of settings of various kinds of information or the like via the input part 108. The I/F107 is an interface to transmit and receive various kinds of information with an output part 109. The output part 109 outputs, for example, various kinds of information stored in the storage unit 104, a process situation of the first terminal 1, the second terminal 2, the third terminal, and the like. As the output part 109, a display is used, and may be, for example, a touchscreen.

<First Terminal 1>

The first terminal 1 acquires the video information at the first site 20. The first terminal 1, for example, acquires the procedure information 10a shown on the object 4a (such as a display board) that is installed in a shop and displays the payment procedure, and delivers it to the second terminal 2 or the third terminal 3 at the second site 30 via the management server 5 or directly. The first terminal 1 at the first site 20, for example, photographs a scene, a town, a shop, or the like at the first site 20 using, for example, the known camera disposed in the first terminal 1, and besides, acquires the procedure information 10a displayed on the object 4c installed, for example, in the town and the shop at the first site 20.

The first terminal 1 delivers the acquired procedure information 10a to the second terminal 2 at the second site 30 via the management server 5 or directly in real time. For example, the first terminal 1 and the second terminal 2 may be preliminarily determined as the terminals that share experience and a procedure between the first site 20 and the second site 30 by the management server 5.

To the first terminal 1, the executer who performs photographing at the (for example, on-site) first site 20 inputs conditions for various kinds of execution information, such as experience that can be shared with and a procedure that can be provided to, for example, the requester at the second site 30. As the first terminal 1, a mobile phone (a mobile terminal) is mainly used, and other than that, in addition to an electronic device, such as a smart phone, a tablet terminal, a wearable device, a personal computer, and an IoT device, any electronic device that embodies the experience may be used. For example, in addition to being connected to the procedure sharing system 100 over the communication network 7, for example, the first terminal 1 may be directly connected to the second terminal 2.

The first terminal 1, may be, for example, constituted of a plurality of terminals, and in the case, the same shared information may be delivered to a plurality of the second terminals 2 via the management server 5 or directly. Additionally, the first terminal 1 may be, for example, a plurality of terminals, and may deliver the procedure information 10a, the procedure information lob, or the procedure information 10c acquired by each of the terminals to one second terminal 2,

<Second Terminal 2>

The second terminal 2 is, for example, a television, a display, a personal computer, a tablet, a smart phone, or a projector at the second site 30 (such as a remote location), and only needs to be a device including any sort of a monitor or a projection device. The second terminal 2 displays the procedure information 10a to 10c together with the video information acquired by the first terminal 1 at the first site 20. The video information and the procedure information delivered to the second terminal 2 are acquired via the management server 5 or the first terminal 1.

The second terminal 2, for example, receiving the delivery of the video information and the procedure information 10a to 10c delivered by the management server 5 or the first terminal 1 displays the delivered video information and procedure information 10a to 10c in the monitor, the display, or the like of the second terminal 2. Note that the second terminal 2, for example, may include the camera 2a to acquire the procedure information displayed in the third terminal 3.

<Third Terminal 3>

The third terminal 3 is a terminal to perform a process for sharing the procedure with the first site 20 by the procedure person who shares the procedure at the second site 30 (the remote location). The third terminal 3 acquires the procedure information 10a displayed in the second terminal 2, for example, and a process of procedure sharing of the procedure information 10a with the management server 5 or another server is performed via the third terminal 3 of the procedure person.

The third terminal 3, for example, acquires the procedure information 10a and displays the procedure information lob such that the third terminal 3 can perform the procedure on the acquired procedure information 10a. The third terminal 3 performs the process of sharing the procedure with the procedure information 10b with, for example, the management server 5 or a corresponding server.

The third terminal 3, for example, may display procedure information 10h of the procedure person himself/herself described later and perform a process (for example, the third terminal 3→the second terminal 2→the first terminal 1) reverse to the one described above. For example, as the third terminal 3, a mobile phone (a mobile terminal) is mainly used, and other than that, in addition to an electronic device, such as a smart phone, a tablet terminal, a wearable device, a personal computer, and an IoT device, any electronic device that embodies the experience may be used.

For example, in addition to being connected to the procedure sharing system 100 over the communication network 7, for example, the third terminal 3 may be directly connected to the first terminal 1 or the second terminal 2.

«First Site 20»

The first site 20 is a site from where the on-site experience or procedure is shared, and, for example, a place away from the second site 30. The first site 20, for example, is registered with the management server 5 via the first terminal 1 by the executer (the photographer). In addition to the place where the executer is currently located, the first site 20 may be a place where the executer will go out later, and is registered together with information, such as a place, date and time, with the management database 6a.

«Second Site 30»

The second site 30 is a site to where the on-site experience or procedure is shared and, for example, a place away from the first site 20. The second site 30 is registered with the management server 5 via the second terminal 2 by the requestor. The second site 30 is a place where the requestor or the procedure person of procedure is present. The second site 30 is registered together with information, such as date and time, with the management database 6a described later.

The respective first site 20 and second site 30 may be different sites. Regarding the first site 20 and the second site 30, for example, the first site 20 may be, “◯◯, Sapporo city, Hokkaido”) and the second site 30 may be “◯◯, Chiyoda-ku, Tokyo”), or the first site 20 may be “◯◯, New York, USA”) and the second site 30 may be “◯◯, Yokohama city, Kanagawa”), and further may be, for example, different floors and rooms in the same buildings.

Additionally, for example, each of the first site 20 and the second site 30 may be moved, when the first site 20 is “from ◯◯, Sapporo city to ◯◯, Hakodate city”, an experience at the site after the movement can be referred to by the second terminal 2 at the second site 30, and various procedure sharing processes at another site are possible with identification information included in a video acquired by an instruction by the requestor.

«Information»

The video information is photographed by the first terminal 1 at the first site 20 among the plurality of sites. The video information is video information at the first site 20 including at least any of location information, such as an address and latitude and longitude at the first site 20, identification information, such as a unique ID identifying the first site 20, and information regarding, for example, a payment procedure, a reservation procedure, a vicarious execution procedure, and an approval procedure regarding the object 4 at the first site 20 between the first terminal 1 and the preliminarily connected second terminal 2 at the second site 30.

«Procedure Information»

The procedure information 10a is, for example, information displayed on the object 4 at the first site 20, for example, information preliminarily generated by converting a price of a product “¥1000” and information regarding the procedure of the product in a two-dimensional code.

The procedure information 10a displayed in the second terminal 2 is acquired, and the acquired procedure information 10a is displayed according to a procedure sharing application (not illustrated) preliminarily installed on the third terminal 3. The procedure information 10b is information regarding a procedure for the management server 5, the terminal at the shop, or another management server or a payment server at the first site 20.

The procedure information 10a (the QR code) and information related to the procedure information 10a are displayed together in the procedure information 10c.

Additionally, procedure information 10d is, for example, a QR code indicating an authentication ID in the third terminal 3.

Procedure information 10e is information regarding a procedure including the procedure information 10d of the third terminal 1 displayed in the first terminal 1 via the second terminal 2, and displayed, for example, ‘THIS SCREEN IS DEDICATED FOR ID123-456.’ indicative of being the identification information of the third terminal 3.

The procedure information 10f is in the fourth terminal 4 (not illustrated) that reads data of the shop at the first site 20, for example, and provided in, for example, a cash register of each shop.

The procedure information 10h or 10i is, for example, a screen example displayed by acquiring, for example, associated information based on the procedure information 10a. In this example, as information regarding a shared procedure, for example, the procedure information 10h as an image of a shop acquiring the procedure information 10a and procedure information 10i as additional information regarding a procedure regarding the acquired expiration date are set together.

When there are a plurality of pieces of the procedure information 10a of the shops (for example, a shop A to a shop F) delivered by a video information delivery unit 14, a plurality of pieces of procedure information 10j are displayed as a plurality of pieces of procedure information at the first site based on at least any information of the object information, the procedure person information, the procedure location information, the procedure period information, and the payment information included in the procedure information in a state where the procedure can be shared on the second terminal 2.

Note that the procedure information 11a is a display, for example, acquired by masking the procedure information 10a displayed on the object 4a in the first terminal 1 at the first site 20 according to security setting or setting of the requestor.

For example, procedure information 11b is a display of information regarding a procedure in the third terminal 3 at the second site 30, and is a confirmation screen regarding a payment procedure at the first site 20.

Therefore, for example, with the procedure information 11b, when the third terminal 3 acquires the procedure information 10a displayed in the second terminal 2, the third terminal 3 discriminates the procedure information 10a, selects a procedure of paying “¥1000” or a cancellation procedure as a procedure according to the procedure information 10a, and performs the procedure on a payment vicarious execution management serve (not illustrated) of a procedure destination identified with a URL of a payment destination.

In the procedure information 10a, for example, in addition to the URL information for performing the procedure as described above, information identifying a procedure by a procedure application installed on the third terminal 3 may be recorded, and whether the procedure is performed by any of, for example, the third terminal 3, URL, and another payment vicarious execution server is arbitrary.

<Display of Procedure Information>

The procedure information 10a is, for example, displayed on the objects 4a to 4c at the first site 20. For example, the first terminal 1 acquires the procedure information 10a as, for example, a part of or all of the imaged video information. For example, the procedure information 10a is delivered to the second terminal 2 connected to the first terminal 1 by being included in the video information via the management server 5. The procedure information 10a is, for example, delivered directly from the procedure-performed or connected first terminal 1 to the second terminal 2 or the third terminal 3 at the second site 30. A monitor or the like provided in the second terminal 2 displays the procedure information 10a.

The procedure information 10a is, for example, acquired by being included in the on-site video information via, for example, the first terminal 1 as information of, for example, a procedure shared between the first terminal 1 at the first site 20 and the second terminal 2 at the second site 30. The video information may have various data formats imaged at the first site 20 including a voice or an image.

The video information may include, for example, information regarding a location, a situation, or the like where the procedure information 10a is imaged and information regarding a time. In addition to the video information being imaged by the known camera disposed in the first terminal 1, the video information may be captured using the known camera connected to the first terminal 1.

For example, as illustrated in FIG. 1, in the procedure sharing system 100, the first terminal 1 may acquire the procedure information 10a displayed on the object 4c. The object 4c may be, for example, a tablet provided in the shop at the first site 20, and the procedure information 10a may be displayed on the screen of the tablet. The object 4c may be, for example, procedure data regarding the procedure information 10a of any of the payment procedure, the reservation procedure, the vicarious execution procedure, and the approval procedure of the product sold at the shop and operated by a shop assistant of the shop.

<Generation of Procedure Information>

The procedure information 10a, for example, may be generated by the known barcode and another multidimensional code, in addition to the known two-dimensional code, for example. The procedure information 10a may be constituted by, for example, a URL and a character string including alphameric characters showing a specific procedure and information (not illustrated). The procedure information 10a is data regarding the procedure shared between, for example, the first terminal 1, the second terminal 3, and the third terminal 3.

Specifically, the procedure information 10a is, for example, the payment procedure, the reservation procedure, the vicarious execution procedure, and the approval procedure, and, for example, is generated by converting the data as the two-dimensional code by the known multidimensional coding technique. The procedure information 10a is, for example, preliminarily set as a process for the product by a manager of the shop, and the set procedure is generated as the procedure information 10a.

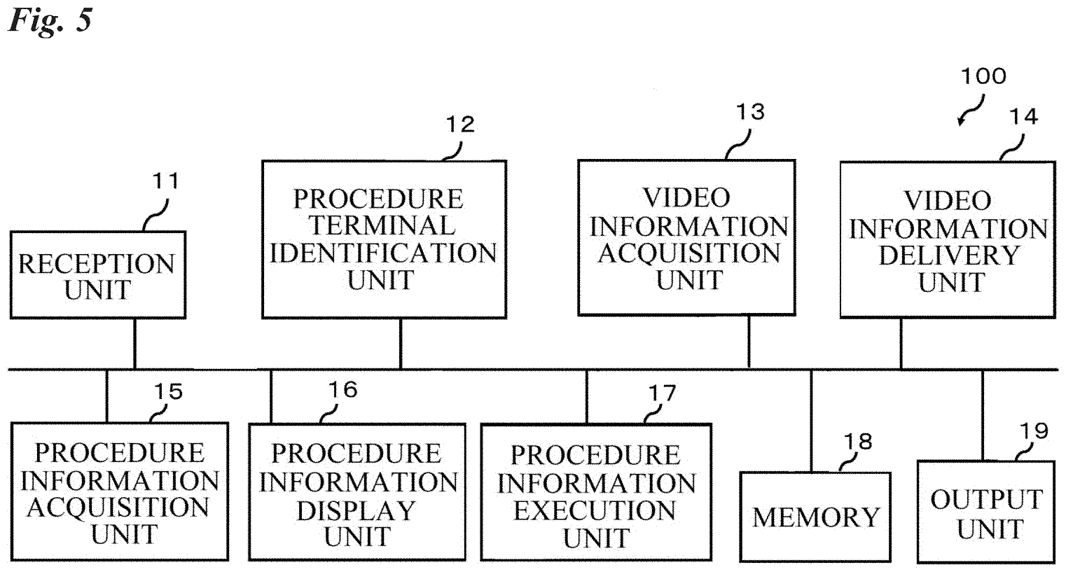

Next, with reference to FIG. 5, an example of a function of the procedure sharing system according to this embodiment will be described. The procedure sharing system 100 includes a reception unit 11, a procedure terminal identification unit 12, a video information acquisition unit 13, the video information delivery unit 14, a procedure information acquisition unit 15, a procedure information display unit 16, a procedure information execution unit 17, a memory 18, and an output unit 19. Note that each function illustrated in FIG. 5 is achieved by executing the program stored in, for example, the storage unit 104 with the RAM 103 as the working area by the CPU 101. A part of the respective functions may be controlled by artificial intelligence. Here, the “artificial intelligence” may be based on any well-known artificial intelligence technique.

<Reception Unit 11>

The reception unit 11 receives each of the request information regarding the request of sharing experience or a procedure from the second terminal 2 (or the third terminal 3) at the second site 20 that requests the sharing of the experience or the procedure and the execution information regarding performing the sharing of experience or procedure from the first terminal 1 at the first site that performs the sharing of experience or procedure. The reception unit 11 receives the execution information from the first terminal 1 and the request information and the procedure information from the second terminal 2 over the communication network 7 and the I/F106.

Note that a frequency and a cycle of the reception unit 11 receiving the request information, the procedure information, and the execution information may be arbitrary. In response to the request from the first terminal 1 or the second terminal 2, the reception unit 11 receives the request information in which a condition including a compensation to be paid is described and the execution information in which a desired compensation for the experience is described. Furthermore, the reception unit 11 receives the request information in which conditions regarding a location and a time of sharing the experience are described and the execution information in which the location and the time where the experience can be performed are described.

<Procedure Terminal 1dentification Unit 12>

The procedure terminal identification unit 12, for example, determines the experience shared between the first terminal 1 at the first site 20 and the second terminal 2 at the second site 30 based on the request information and the execution information received by the reception unit 11. The procedure terminal identification unit 12 may determine the procedure shared between the first terminal 1 at the first site 20 and the second terminal 2 at the second site 30.

The procedure terminal identification unit 12, for example, determines the first terminal 1 and the second terminal 2 that share the experience or the procedure based on whether to match the information including at least any of the location and the time included in each of the execution information received from the first terminal 1, the request information received from the second terminal 2, and the procedure information via a platform provided by, for example, an application and a website provided by the procedure sharing system 100.

The storage unit 104 stores the experience or the procedure determined by the procedure terminal identification unit 12. Further, the procedure terminal identification unit 12 may determine the first terminal 1 and the second terminal 2 that share the experience or the procedure based on the compensations described in the respective request information, procedure information, and execution information received by the reception unit 11.

<Video Information Acquisition Unit 13>

The video information acquisition unit 13 acquires the video information at the first site including at least any of the location information at the first site 20, the identification information identifying the first site 20, and the procedure information regarding the procedure at the first site 20 between the first terminal 1 at the first site 20 and the second terminal 2 at the second site 30 preliminarily connected to the first terminal 1 among the plurality of sites. When the first terminal 1 can acquire the shared information including the voice or the image to share in the experience or the procedure determined by the procedure terminal identification unit 12 or the objects 4a to 4c, the video information acquisition unit 13 acquires it.

The video information acquisition unit 13 acquires information shared in the determined experience or procedure in the first terminal 1 at the first site and the second terminal 2 at the second site over the communication network 7 and the 1/F106. The video information acquisition unit 13, for example, images the video information, such as a scene, at the first site 20 via the first terminal 1 by the executer, and further while photographing the video information, such as a scene, for example, also acquires the procedure information 10a pasted to or displayed on the object 4. The video information acquisition unit 13 acquires the video information including, for example, the location information regarding the site at the first site 20, the identification information identifying the first site 20, and the procedure information regarding the procedure at the first site 20. Additionally, the procedure information acquisition unit 12 acquires state information regarding the state of the voice or the image included in the video information.

Here, the state information is, for example, the state information regarding the voice or the image delivered to the second terminal 2, and, for example, may be information, such as the states of the devices regarding the first terminal 1 and the second terminal 2, a state of a radio wave and a packet to be transmitted and received, intensity of the communications, and further a battery state. Furthermore, the procedure sharing database 6b may store situation information of a situation regarding a location, such as a positional coordinate and GPS information where the video information or the procedure information shared by the first terminal 1 is acquired, and the procedure information, such as the type, the property, the condition, the target, and a coupon related to the contents of the shared information, and the video information acquisition unit 13 may appropriately acquire it based on the location information of the first terminal 1 at the first site 20.

The video information acquisition unit 13 may acquire the video information or the procedure information by the first terminal 1 after the procedure terminal identification unit 12 determines the experience or the procedure and the payment for the compensation is made.

<Video Information Delivery Unit 14>

The video information delivery unit 14 delivers the video information acquired by the video information acquisition unit 13 to the second terminal 2 at the second site 30 in real time. The video information delivery unit 14 delivers the video information and the procedure information acquired from the first terminal 1 at the first site 20 to the second terminal 2 as if it were seen in real time over the communication network 7 and the I/F 107. The video information delivery unit 14, for example, may adjust the voice and the image of the shared information, the resolution, the capacity, the image size, or the like of the procedure information based on the video information acquired by the video information acquisition unit 13 and deliver it to the second terminal 2.

The video information delivery unit 14, for example, delivers the procedure information 10a included in the video information to the second terminal 2 at the remote location to allow, for example, the requestor at the second site to see the scene, the mountain and the river, the town, the shop, the inside of the shop, the product displayed inside the shop, and the like at the on-site first site 20 while staying at the remote location. Further, when the object 4, such as the product, has the procedure information 10a regarding, for example, the payment procedure, the reservation procedure, the vicarious execution procedure, and the approval procedure regarding the object 4, the details of the object 4 can be known with the procedure information 10a. The video information delivery unit 14 delivers the situation information regarding the situation of the location where the video information and the procedure information are acquired by the first terminal 1, to the first terminal 1 or the second terminal 2 transmit. In view of this, while each of the first terminal 1 and the second terminal 2 remotely shares the experience and the procedure, the situation information according to the location where, for example, the video information and the procedure information are acquired can be acquired.

Additionally, the video information delivery unit 14, for example, may use additional value information, such as detailed information of description regarding the place where video information and procedure information are acquired, a subject, the object, or the like, and coupon information of the shop that has reopened as, for example, a situation of the position delivered to the second terminal 2. The situations of the positions may be, for example, preliminarily stored in or registered with the procedure sharing database 6b, and provided based on, for example, the identifiers regarding the position of the video information and the procedure information acquired by the first terminal 1. This configuration allows providing information unknown to the on-site executer to the requestor.

Additionally, the video information delivery unit 14 may transmit, for example, notice information regarding acquisition of the video information, and information regarding the on-site situation and the situation of photographing, such as complementary information, to only the first terminal 1 at the first site 20 based on the video information acquired at the first site 20. The information may be, for example, preliminarily stored in or registered with the management database 6a or the procedure sharing database 6b, and provided to the first terminal 1 based on, for example, the identifiers regarding the locations of the video information and the procedure information acquired by the first terminal 1. This configuration allows providing the further good video information and procedure information to the executer of photographing.

<Procedure Information Acquisition Unit 15>

The procedure information acquisition unit 15 acquires the procedure information in the case where the video information delivered by the video information delivery unit 14 includes the procedure information. The procedure information acquisition unit 15, for example, preliminarily stores various kinds of information regarding the procedure information 10a as the comparison target for various kinds of information and images photographed by the first terminal 1 at the first site 20 in, for example, the management database 6a. The procedure information acquisition unit 15, for example, compares the comparison target information stored in the management database 6a with the images and the like, and extracts all or a part of the procedure information 10a in the video information photographed by the first terminal 1.

When, for example, the procedure information 10a is the QR code displayed on the object 4a, the procedure information acquisition unit 15 detects a marker included in the QR code from the video information and acquires the detected QR code as the procedure information 10a. When, for example, the acquired procedure information 10a is the QR code, the procedure information acquisition unit 15 may acquire it as, for example, a still picture and a capture such that the procedure information 10a is not deployed in the first terminal 1 or the second terminal 2. Note that, for example, the QR code is appropriately generated and displayed on the objects 4a to 4c and the like based on information, such as the known various formats and rules regarding the QR code and based on the related art of the code appropriately from the procedure information 10a.

For example, when the video information from the second terminal or the third terminal includes the procedure information 10a, the procedure information acquisition unit 15 may designate the acquisition of the procedure information 10a by the input from the second terminal 2 or the third terminal 3 (for example, an acquisition instruction of the procedure information 10a by, for example, a chat and a mail through a keyboard or using a microphone and a speaker). The first terminal 1 at the first site 20, for example, may acquire the procedure information 10a in the first terminal 1 at the first site 20 according to the designation of the procedure information 10a input from the second terminal 2 or the third terminal 3 at the second site 30.

The procedure information acquisition unit 15 may, for example, correct and edit the acquired procedure information 10a regarding, for example, the display of the procedure information 10a such that the procedure information 10a is correctly displayed in the procedure information display unit 16 as the display destination.

<Procedure Information Display Unit 16>

The procedure information display unit 16 displays the procedure information 10a acquired by the procedure information acquisition unit 15, for example, as the procedure information 10a at the first site 20 in a state where the procedure can be shared on the second terminal 2 as the procedure information 10a at the first site 20 based on the location information where the procedure information 10a is acquired and the identification information.

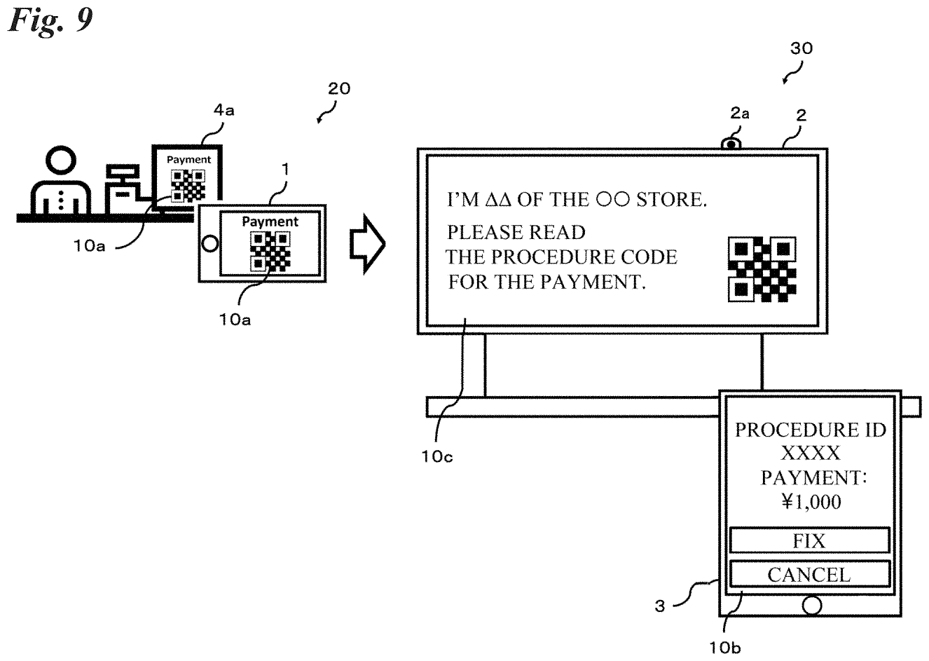

For example, as illustrated in FIG. 9, when the procedure information display unit 16 displays the procedure information 10a (the QR code) displayed on the object 4a at the first site 1 in the second terminal 2 at the second site 2, the object 4c may be, for example, a tablet provided in the shop at the first site 20, and the procedure information 10a may be displayed on the screen of the tablet. The object 4c may be operated by, for example, a shop assistant of the shop, and may be procedure data regarding the procedure information 10a of any of the payment procedure, the reservation procedure, the vicarious execution procedure, and the approval procedure of the product sold at the shop.

Additionally, when there are a plurality of pieces of the procedure information 10a delivered by the video information delivery unit 14, the procedure information display unit 16 may display the plurality of pieces of procedure information 10a or the like in a state where the procedure can be shared on the second terminal as the procedure information at the first site based on at least any information of the object information, the procedure person information, the procedure location information, the procedure period information, and the payment information included in the procedure information 10a.

<Procedure Information Execution Unit 17>

The procedure information execution unit 17, for example, based on the procedure information 10a displayed by the procedure information display unit 16, performs the procedure at the first site 20 as the procedure by the third terminal at the second site 30. The procedure information execution unit 17, for example, based on the procedure information 10c displayed by the procedure information display unit 16, acquires the procedure at the first site as the procedure information 10c displayed at the second site 30 and performs it as the procedure by the third terminal.

<Memory 18>

The memory 18 stores preliminarily acquired various kinds of information and additionally input various kinds of information. The information stored in the memory 18 is, for example, stored in the management database 6a and the procedure sharing database 6b in the management server 5.

<Output Unit 19>

The output unit 19 outputs, for example, situation, such as an acquisition situation of various kinds of shared information and various setting information, a delivery situation by the video information delivery unit 14, the video at the first site 20 by the procedure information display unit 16, the display of procedure information, the contents of shared procedure, and the authentication result. In addition to outputting the shared information and the identification information acquired by the first terminal 1 to the output part 109 via the I/F 107, the output unit 19 transmits any various kinds of related information including the video information and the procedure information 10a to the first terminal 1, the second terminal 2, the third terminal 3, and the like by the video information delivery unit 14 via the 105.

<Management Database 6a>

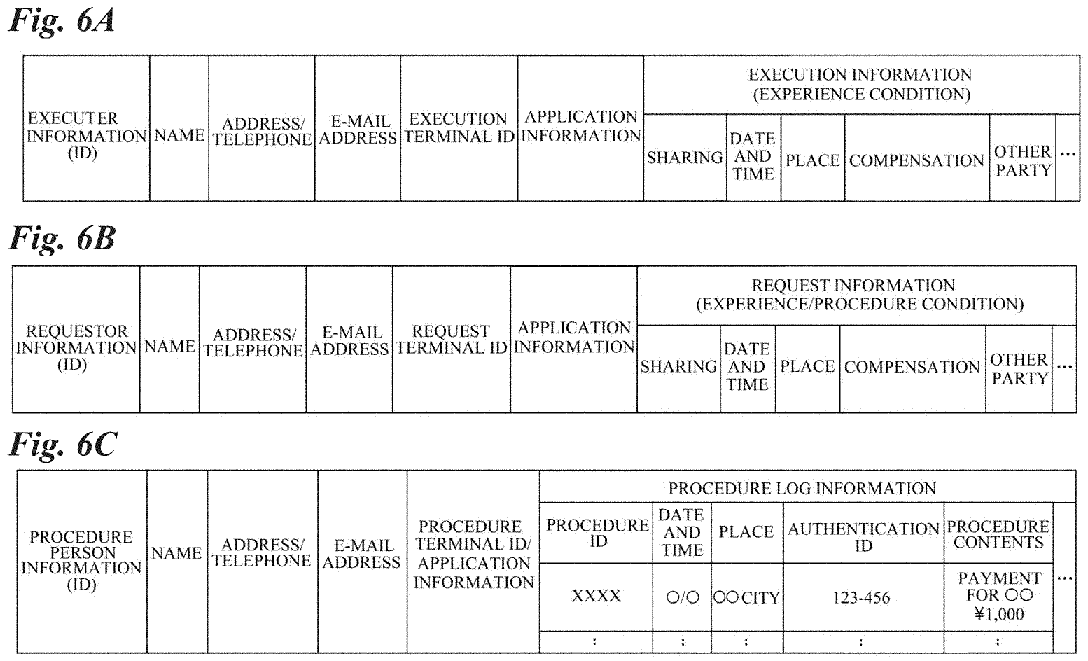

In the management database 6a, for example, as an executer information data table illustrated in FIG. 6A, each piece of information, such as “executer information OD),” “name,” “address/telephone,” and “e-mail address” identifying the executer who operates the first terminal 1, “execution terminal ID” and “application information” regarding the first terminal 1, and as the execution information (the experience/procedure condition) regarding the shared experience and procedure, “sharing” as the contents of the shared experience, “date and time” when the shared experience is performed, “place” of the shared experience. “compensation” as the amount of money for the shared experience, and “other party” (such as the second terminal 2, the third terminal 3, the procedure person) as the other party with whom the experience is shared is made to correspond and preliminarily stored.

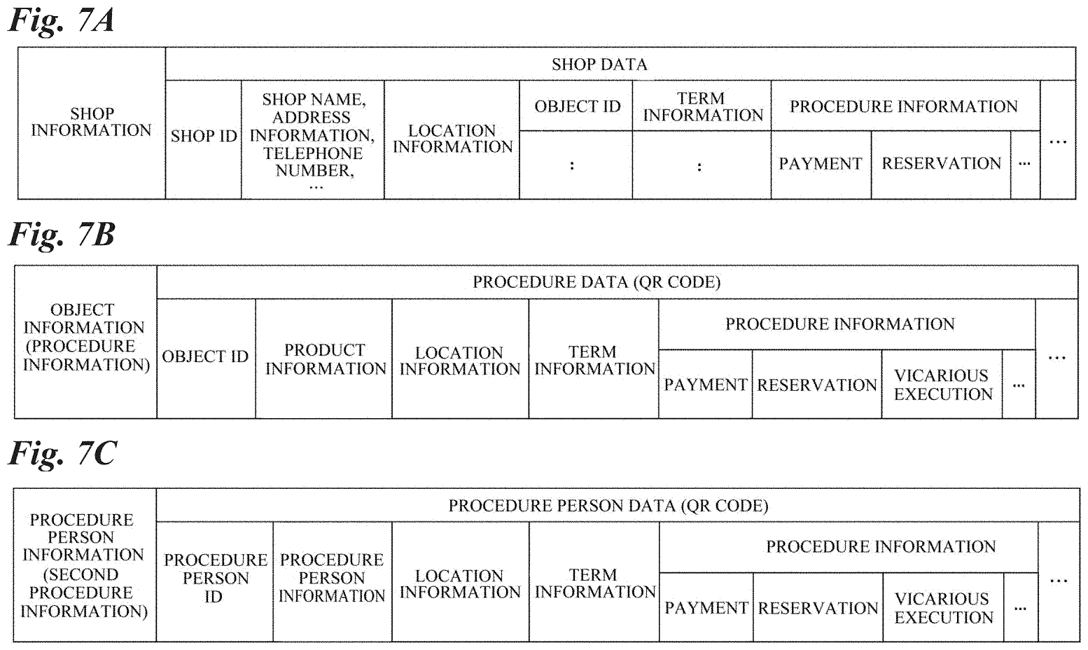

Additionally, in the management database 6a, for example, as a requestor information data table illustrated in FIG. 7B, each piece of information, such as “requestor information (ID),” “name,” “address/telephone.” and “e-mail address” identifying the requestor who operates the second terminal 2 or the third terminal 3, “request terminal 1D” and “application information” regarding the second terminal 2, and as request information (the experience/procedure condition) regarding the experience and the procedure desired to be shared “sharing” as the contents of the experience desired to be shared, “date and time” when the experience desired to be shared is shared, “place” of the shared experience, “compensation” as the amount of money of the shared experience, and “other party” as the other party who shares the experience (the first terminal 1, the fourth terminal 4, and the like) is made to correspond and preliminarily stored.

Additionally, in the management database 6a, for example, as illustrated in FIG. 7C, as a procedure person information data table, each piece of information, such as “procedure person information (ID),” “name,” “address/telephone,” and “e-mail address” identifying the procedure person who performs the procedure from the second terminal 2 or the third terminal 3, “procedure terminal 1D” and “application information” regarding the third terminal 3, and as procedure log information regarding logs of sharing and procedure, “procedure ID (XXXX)” identifying the shared procedure. “date and time (◯ month ◯ day)” of the shared procedure, “place (◯◯ city)” of the shared procedure, “authentication ID (123-456)” regarding authentication of the shared procedure, “procedure contents (payment for ◯◯, ¥1,000)” regarding the amount of money for the shared procedure, and “other party” regarding the other party (the first terminal 1, the fourth terminal 4, and the like) who shares the experience is made to correspond and preliminarily stored.

<Procedure Sharing Database 6b>

The procedure sharing database 6b, stores, for example, as illustrated in FIG. 7A, shop data regarding the shop at the first site 20 as shop information data table. In the shop information data table, for example, each piece of information, such as “shop ID” and “shop name, address information, telephone number, and the like” identifying the shop where the object 4 (the object 4a, the object 4b, and the object 4c) is installed, “location information” indicating the location where the object 4 is installed, “object ID” identifying the object 4, “term information” regarding the term of the object ID, and “payment” and “reservation” as the procedure information regarding the shared procedure is made to correspond and preliminarily stored.

For example, as illustrated in FIG. 7B, the procedure sharing database 6b stores the procedure information regarding the object 4 at the first site 20 in an object information data table. In the object information data table, each piece of information, such as “object ID” identifying the objects 4a to 4c, “product information” regarding the type and the medium name of the objects 4a to 4c and the product name, “location information” indicating the location where the objects 4a to 4c are installed, “term information” regarding the term of the objects 4a to 4c, and “payment” and “reservation” as the procedure information regarding the procedure shared in the objects 4a to 4c is made to correspond and preliminarily stored.

In the procedure sharing database 6b, for example, as illustrated in FIG. 7C, information regarding the procedure person (second procedure information) regarding the procedure person who shares the procedure at the second site 30 via the third terminal 3 is stored in the procedure person information data table. In the procedure person information data table, for example, each piece of information, such as “procedure person ID” identifying the procedure person, “identifier information” regarding the procedure person, such as the name, the age, the sex, and the address of the procedure person, “location information” indicating the location where the procedure person has performed the procedure, “term information” regarding the term during which the procedure person can perform the procedure via the third terminal 3, and “payment,” “reservation,” and “vicarious execution” as the procedure information regarding the procedure shared by the procedure person is made to correspond and preliminarily stored.

<Communication Network 7>

The communication network 7 is, for example, an Internet network to which the procedure sharing system 100 or the like is connected via a communication circuit. The communication network 7 may be constituted by what is called optical fiber communication network. Additionally, the communication network 7 may be achieved by, the known communication network, such as a wireless communication network, in addition to a wired communication network.

(Example of Operation of Procedure Sharing System 100)

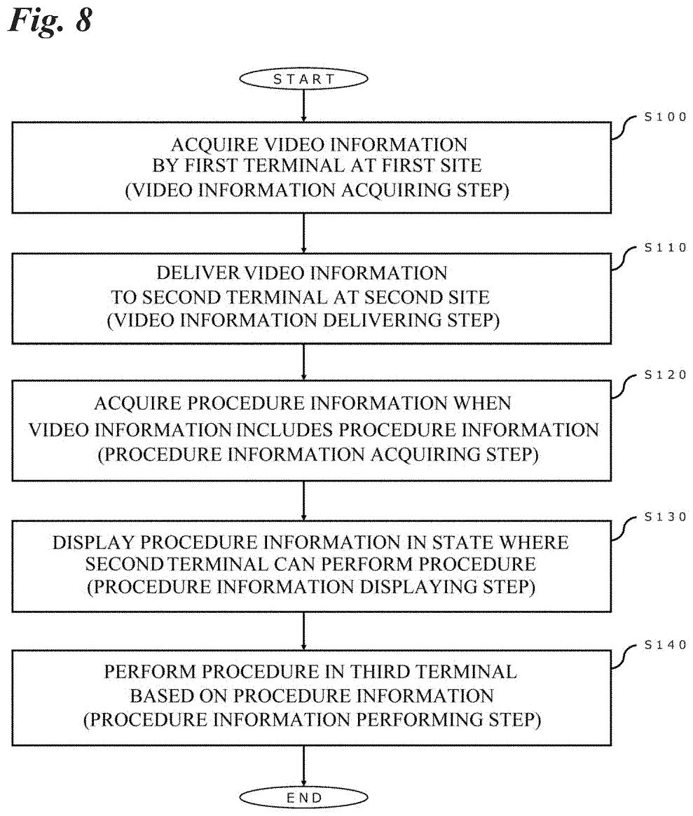

Next, with reference to FIG. 8, an example of a sequence of the procedure sharing process in the object, the first terminal, the second terminal, and the third terminal of the procedure sharing system in the embodiment will be described.

<Receiving Means Step>

First, at the receiving means step, each of the execution information regarding performing the experience from the first terminal 1 and the request information regarding the request of the experience from the second terminal 2 is received. In the receiving means, for example, each of the execution information regarding sharing the experience or the procedure from the first terminal 1 at the first site that shares the experience or the procedure, and the request information regarding the request of sharing the experience or the procedure from the second terminal 2 (or the third terminal 3) at the second site 20 that requests sharing of the experience or the procedure is received. The receiving means stores each piece of the received information in the management database 6a (for example, FIG. 6A to FIG. 6C).

At the receiving means step, for example, the requestor and the executer compare the request information and the execution information received by the reception unit 11, and, for example, by a priority and a degree of match of each item, the first terminal 1 at the first site 20 may be matched with the second terminal 2 at the second site 30.

For example, in the matching between the first terminal 1 and the second terminal 2, the respective sites and the terminals at the respective sites are determined based on the match of the various kinds of information or data, such as respective sharing targets, dates and times, places, and compensations included in, as illustrated in FIG. 6A, the executer information data table registered by the executer who can perform photographing on-site (the first site 20) and, for example, as illustrated in FIG. 6B, the requestor information data table registered by the requestor who desires to watch the video information including the on-site procedure information 10a and perform the procedure at the remote location (for example, the second site 30).

<Procedure Terminal 1dentifying Means Step>

At the procedure terminal identifying means step, for example, based on the request information and the execution information received by the reception unit 11, the experience, which is shared between the first terminal 1 at the first site 20 and the second terminal 2 at the second site 30, and the first terminal 1 and the second terminal 2, which allow the procedure of the procedure information 10a acquired through the experience, are determined. At the procedure terminal identifying means step, the procedure shared between the first terminal 1 at the first site 20 and the second terminal 2 at the second site 30 may be determined.

At the procedure terminal identifying means step, for example, the first terminal 1 and the second terminal 2 that share the experience or the procedure may be determined via an application provided by the procedure sharing system 100 and a platform provided on a website or the like.

The experience and the shared procedure determined by the procedure terminal identification unit 12 is stored, for example, in the storage unit 104. Further, the procedure terminal identification unit 12 may determine the first terminal 1 and the second terminal 2 that share the experience or the procedure based on the compensation described in each of the request information, the procedure information, and the execution information received by the reception unit 11.

«Video Information Acquiring Means S100»

The video information acquiring means S100 acquires the video including at least the location information at the first site 20, the identification information identifying the first site, and the procedure information 10a regarding the procedure at the first site 20, for example, between the first terminal 1 among the plurality of sites at the first site 20 and the second terminal 2 at the second site 30 preliminarily connected to the first terminal 1 as on-site video information (video information acquiring means S100).

At the video information acquiring means S100, for example, the first terminal 1 at the first site 20 acquires the on-site video information. As the video information, the location information at the first site 20, the identification information identifying the first site 20, and the procedure information 10a regarding the various procedures at the first site 20 are acquired.

At the video information acquiring means S100, the first terminal 1 at the first site 20 acquires the acquired video information by an imaging device (not illustrated), such as the camera provided in the first terminal 1. The video information acquired by the first terminal 1 may be acquired based on instruction information of photographing by the second terminal 2 or the third terminal 3 at the second site 30.

At the video information acquiring means S100, the video information is acquired via the management server 5, and besides, may be acquired directly between the first terminal 1 and the second terminal 2.

«Video Information Delivering Means S110»

At the video information delivering means S110, the video information acquired at the video information acquiring means S100 is delivered to the second terminal 2 at the second site 30 in real time (video information delivering step S110).

At the video information delivering means S110, the first terminal 1 at the first site 20 and the second terminal 2 at the second site 30 are connected in real time. At the video information delivering means S110, the video information acquired in the first terminal 1 at the first site 20 is delivered to the second terminal 2 as a video as if the on-site situation were seen in real time in the second terminal 2 at the second site 30. At the video information delivering means S110, for example, the state and the property of the video information acquired at the video information acquiring means S100 may be evaluated, and based on the evaluation result, the voice and the image of the shared video information and the resolution, the capacity, the image size, and the like of the procedure information 10a may be adjusted and the video information may be delivered to the second terminal 2. This allows delivery of the stable video information,

The video information delivering means S110 may perform transmission to only the first terminal 1 at the first site 20 based on the video information acquired at the first site 20, for example, based on notice information regarding acquisition of the video information and the on-site situation and the photographing situation, such as complementary information. The information may be, for example, preliminarily stored in or registered with the management database 6a or the procedure sharing database 6b, and provided to the first terminal 1 based on, for example, each of the identifiers regarding the locations of the video information and the procedure information acquired by the first terminal 1. This configuration allows the executer to concentrate on further good photographing for the video information and the procedure information 10a.

«Procedure Information Acquiring Means S120»

At the procedure information acquiring means S120, when the procedure information 10a is included in the video information delivered at the video information acquiring means S110, the procedure information 10a is acquired (procedure information acquiring means S120).

The procedure information acquiring means S120 discriminates the video information delivered by the video information acquiring means S110 and acquires the procedure information 10a according to the result of discrimination when the procedure information 10a is included. The procedure information acquiring means S120 may compare, for example, the various kinds of information and images photographed by the first terminal 1 at the first site 20 based on, for example, the various kinds of information regarding the procedure information 10a as the comparison target preliminarily in the management database 6a, and all or a part of the procedure information 10a may be extracted from the video information photographed by the first terminal 1.

At the procedure information acquiring means S120, for example, when the procedure information 10a is the QR code displayed on the object 4a, a marker included in the QR code is detected from the video information. At the procedure information acquiring means S120, the detected QR code is acquired as the procedure information 10a of the object 4 at the first site 20.

At the procedure information acquiring means S120, for example, when the acquired procedure information 10a is the QR code, it may be acquired as, for example, a still picture and a capture such that the procedure information 10a is not deployed in the first terminal 1 or the second terminal 2.

«Procedure Information Displaying Means S130»

At the procedure information displaying means S130, the procedure information 10a acquired at the procedure information acquiring means S120 is displayed on the second terminal 2 at the second site as the procedure information 10a at the first site 20 (the procedure information displaying means S130). At the procedure information displaying means S130, for example, information related to the displayed procedure information 10a is acquired from the procedure sharing database 6b based on the location information at the first site 20 where the procedure information 10a is acquired and the identification information.

At the procedure information displaying means S130, for example, the information related to the displayed procedure information 10a from the procedure sharing database 6b is displayed in a state where the procedure can be shared on the second terminal 2 as the procedure information 10a at the first site 20. At the procedure information displaying means S130, for example, the information related to the procedure information 10a is displayed in the second terminal 2 in a state where the procedure can be performed by the third terminal 3.

At the procedure information displaying means S130, for example, when a plurality of pieces of the displayed procedure information 10a are present in the second terminal 2, based on the location information and the identification information included in the video information at the first site 20 where each piece of the procedure information 10a is acquired and each piece of information related to the information, the display screen of the second terminal 2 may be divided to display each piece of the procedure information 10a (for example FIG. 2, and FIG. 9 to FIG. 12).

At the procedure information displaying means S130, for example, regarding the display at the second site 30 or in the second terminal 2, in a case where restrictions, such as a display target person, the number of times of display, and display time of the displayed procedure information 10a, are set to the second terminal 2, the condition of the set restriction may be applied to the display in the second terminal 2.

Procedure information Performing Means S140»

At the procedure information performing means S140, based on the procedure information 10a displayed at the procedure information displaying means S130, the procedure at the first site 20 is performed on the third terminal 3 at the second site 20 as the procedure by the third terminal 3 (procedure information performing means S140).

At the procedure information performing means S140, for example, the procedure person can perform the procedure of the procedure information 10a displayed on the object 4 at the first site based on the procedure information 10a displayed at the procedure information displaying means S130. For example, the procedure person starts the application provided by the procedure sharing system 100 from the third terminal 3. The third terminal 3, for example, acquires the procedure information 10a by a reader, which reads the procedure information 10a, from a function provided by the application of the procedure sharing system 100 and performs the procedure with the procedure information 10b corresponding to the procedure information 10a.

At the procedure information performing means S140, for example, as the procedure by the procedure person of the third terminal 3, for example, as the procedure information 10a, the procedure, such as “payment,” “reservation,” and “vicarious execution,” are possible. Thus, without going to the first site 20, the procedure person can perform the procedure with the procedure information 10a shared via the second terminal 2 at the first site 20. Note that the third terminal 3 at the second site 30 may be plural, and in this case, the procedure information 10a is shared by many terminals,

By performing the above-described respective means, the operation of the procedure sharing system 100 that shares the procedure between the respective sites according to this embodiment may be terminated.

(First Modification of Operation of Procedure Sharing System 100)

Next, regarding the first modification of the procedure sharing system 100 in one embodiment, the first modification of the operation of the procedure sharing system will be described with reference to FIG. 9.

The difference between the example of the operation described above and the first modification is that, for example, a guide regarding the shop where the procedure information 10a is displayed (installed), associated information regarding the procedure information 10a, and the like are made to correspond to the procedure information 10a displayed on the object 4a at the first site 20.

The guide regarding the shop where the procedure information 10a is displayed (installed), the associated information regarding the procedure information 10a, and the like are recorded in, for example, the procedure sharing database 6b. The associated information recorded in the procedure sharing database 6b may be displayed together with the QR code, the associated information, and the like as the procedure information 10c on the display of the second terminal 2 at the second site 30 in the form of, for example, a message and an image texted as the display in the second terminal 2 based on, for example, preliminarily set terminal information, a log of, for example, the shared procedure information 10a, and information of traceability or the like.

At the procedure information acquiring means S120, the video information delivered at the video information acquiring means S110 is discriminated. According to the result of discrimination at the video information acquiring means S110, when it is determined that, for example, the procedure information 10a is included in the video information and further the associated information regarding the procedure person is added associated with the discriminated procedure information 10a, the identification information is acquired at the procedure information acquiring means S120. The information is, for example, preliminarily generated as the QR code and displayed on the object 4. Reading the QR code displayed on the object 4 by the first terminal 1 at the first site 20 allows acquiring the coded identification information.

At the procedure information displaying means S130, a person at the second site 30 (for example, the requestor and the procedure person) can be informed of, the identification information acquired at the procedure information acquiring means S120, for example, ‘I′M ΔΔ OF THE ◯◯ STORE. PLEASE READ THE PROCEDURE CODE FOR THE PAYMENT.’ together with the procedure information 10a. Thus, the requestor or the procedure person at the second site 30 can confirm the manager of the procedure information 10a (for example, ‘THE ◯◯ STORE,’ ‘I'M ◯◯’) while receiving the sharing of the procedure information 10c. The procedure person at the second site 30 at the remote location can confirm the procedure information 10a as the procedure information 10c even at the remote location, and can perform the procedure in the procedure information 10c.

Additionally, at the procedure information displaying means S130, based on the identification information acquired at the procedure information acquiring means S120, for example, the associated information stored in the procedure sharing database 6b is referred, and when there is information to be displayed in the second terminal 2, it may be displayed on the second terminal 2. For example, the display in the second terminal 2 may be any of only the QR code, the QR code and the associated information included in the procedure information 10a, the QR code and another identification information, or the like, and the display may be appropriately performed according to, for example, the location information of the second site 30, the requestor of the second terminal 2, the information regarding the procedure person, and the like.

At the procedure information displaying means S130, for example, when the procedure information 10a is acquired, the procedure information 10a may be displayed only in the first terminal 1. At the procedure information displaying means S130, for example, display information informing the place where the object 4 is present at the first site 20, display information regarding a safety and a notice when the procedure information 10a on the object 4 is imaged, and the like may be displayed only in the first terminal 1 as necessary based on various kinds of information, such as the state information of the first terminal 1 at the first site 20, environment information, the (on-site) first site situation, a degree of crowding nearby, update and life and death of the procedure information 10a, and a link.

At the procedure information performing means S140, based on the procedure information 10c displayed at the procedure information displaying means S130, the procedure at the first site 20 is, for example, performed as the procedure by the third terminal 3 of the procedure person at the second site 30. At the procedure information performing means S140, for example, the procedure of the procedure information 10c displayed in the second terminal 2 is performed via the second terminal 2 of the procedure person at the second site 30.

Additionally, at the procedure information performing means S140, via the third terminal 3, for example, the QR code displayed in the procedure information 10c may be read, and the management server 5 is accessed from a URL shown by the read QR code to perform the shared procedure (for example, the procedure information 10a on the object 4a at the first site 20). At the procedure information performing means S140, for example, the procedure of the procedure information 10c displayed in the second terminal 2 may be performed via a payment application preliminarily installed on the third terminal 3, and the procedure may be a procedure other than the payment.

At the procedure information performing means S140, via the third terminal 3, for example, after the procedure of the procedure information 10c in the third terminal 3, a notification of procedure completion may be output to the manager of the object 4a at the first site 20 (not illustrated). At the procedure information performing means S140, for example, when it can be confirmed that the situation of the procedure of the procedure information 10c in the third terminal 3 is acquired via the third terminal 3 and the ‘FIX’ button of the procedure information 10b displayed in the third terminal 3 is pressed, the payment procedure may be acquired as procedure result information in the third terminal 3 (for example, ‘THE PAYMENT HAS BEEN MADE. THE PROCEDURE ID XXXX, PAYMENT: ¥1,000, DATE OF PAYMENT YYYYMMDD HH: MM’), and the reply may be performed to the procedure source of the procedure information 10a directly or via the management server 5.

Additionally, the QR code displayed in the procedure information 10c may be read, and the management server 5 is accessed from a URL shown by the read QR code to perform the shared procedure (for example, the procedure information 10a on the object 4a at the first site 20). At the procedure information performing means S140, for example, the procedure of the procedure information 10c displayed in the second terminal 2 may be performed via a payment application preliminarily installed on the third terminal 3, and the procedure may be a procedure other than the payment.

(Second Modification of Operation of Procedure Sharing System 100)

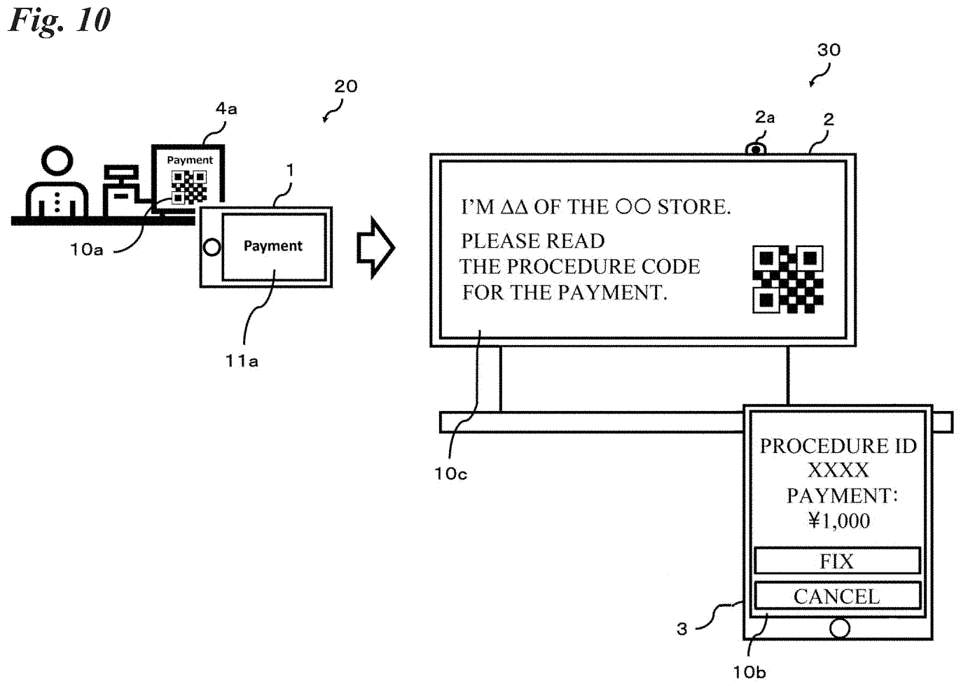

Next, about the first modification of the procedure sharing system 100 in one embodiment, with reference to FIG. 10, the second modification of the operation by the procedure sharing system will be described.

The example of the operation described above differs from the first modification in that, for example, the procedure information 10a acquired at the first site 20 is hidden on the screen of the first terminal 1. This allows avoiding the executer to know the acquisition of the procedure information 10a in the first terminal 1 at the first site, thus covering privacy of the requestor and individual history of the procedure information 10a.

At the procedure information acquiring means S120, for example, the procedure information 10 included in the acquired video information is discriminated. At the procedure information displaying means S130, according to, for example, setting by a person in charge of the object 4a of the first site 20 and a secret of the procedure information 10a acquired by the procedure person, the display restriction of display is performed only on the first terminal 1 at the first site 20.

Which information is displayed on the procedure information 10a displayed on the object 4a may be preliminarily stored in the data table of the management database 6a or the procedure sharing database 6b based on the above-described location information, identification information, and procedure information? At the procedure information acquiring means S120, for example, when the procedure information 10a displayed on the object 4a is acquired from the video information at the first site 20, the first terminal 1 at the first terminal 1, for example, may display ‘PAYMENT’ and the second terminal at the second site 2 may display, similarly to the above description, for example, ‘I'M ΔΔ OF THE ◯◯ STORE. PLEASE READ THE PROCEDURE CODE FOR THE PAYMENT.’

In this case, the data table of the management database 6a or the procedure sharing database 6b stores, as the setting condition of ‘the first site 20, the object 4a, and the procedure information 10a,’ for example, conditions, such as ‘the first site, the first terminal: the procedure information is not disclosed, ‘the second site, the second terminal: the procedure information is disclosed,’ and the procedure information 10a or another information is appropriately displayed according to each site and each terminal.

(Third Modification of Operation of Procedure Sharing System 100)

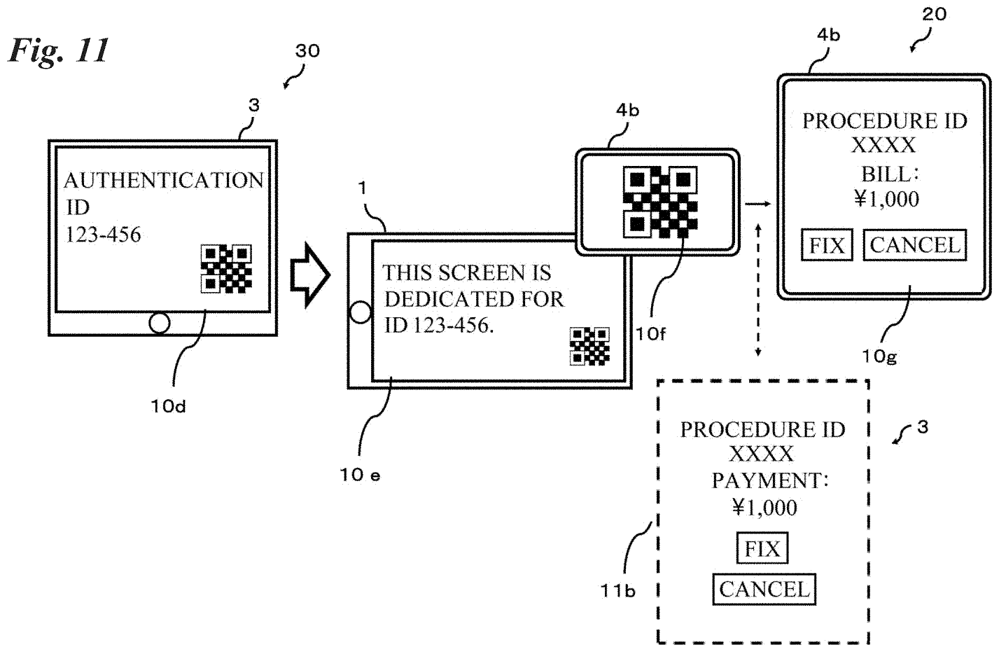

Next, regarding the first modification of the procedure sharing system 100 in one embodiment, a third modification of the operation of the procedure sharing system will be described with reference to FIG. 11. In this case, the procedure in the procedure sharing system 100 is the reverse procedure.

The difference between the above-described example of the operation and the first modification and the second modification is, that for example, the second terminal 2 at the second site 30 acquires the procedure information 10d (such as ‘AUTHENTICATION ID 123-456’), displayed in the third terminal 3 at the second site 20 and shares the procedure with the object 4b in the shop at the first site 20.

At the video information acquiring means S100, for example, at the second site 30, the procedure information 10d regarding the procedure person displayed in the third terminal 3 is acquired. At the procedure information displaying means S130, the first terminal 1 displays the procedure information 10e acquired from the second terminal 2. Then, at the procedure information performing means S140, the object 4b acquires the procedure information 10f displayed in the first terminal 1, and the procedure according to the procedure information 10f by the procedure person can be performed at the first site 30.

At the video information acquiring means S100, for example, the video information at the second site 30 (such as the third terminal 3) is acquired via the camera 2a in the second terminal 2. In a case where the second site 30 is inside a house, the video information may be a default image.

The video information delivering means S110 delivers the video information acquired at the video information acquiring means S100 to the first terminal 1 at the first site 20 in real time.

At the procedure information acquiring means S120, for example, the procedure information 10d displayed in the screen of the third terminal 3 included in the video information at the second site 20 is acquired. The procedure person at the second site 30 may preliminarily cause the third terminal 3 to display authentication information of himself/herself.

At the procedure information displaying means S130, for example, the procedure information 10d displayed in the third terminal 3 acquired at the procedure information acquiring means S120 is displayed via the first terminal 1 at the first site 20 as the procedure information 10e on which the procedure can be performed by the first terminal 1. At the procedure information displaying means S130, for example, a QR code related to ‘THIS SCREEN IS DEDICATED FOR ID 123-456’ is displayed as the identification information based on the identification information identifying the second site 30 and the procedure information 10d regarding the procedure at the second site 30.

For example, via the shop terminal (such as the object 4d) at the acquired first site 20, in the procedure information 10e displayed in the first terminal 1, the procedure information 10f, which includes only the part of the QR code, is acquired. The shop terminal acquires the procedure information 10f, and, for example, performs the procedure regarding the payment. The shop terminal, for example, displays procedure information 10g as the procedure in the shop terminal. At the procedure information performing means S140, the procedure information 11b may be delivered to the third terminal 3 of the procedure person at the second site 30 according to the procedure information 10f acquired via the shop terminal to confirm the payment. The procedure in the shop terminal at the first site 20, for example, may be displayed after the procedure of the procedure information 11b displayed in the third terminal 3 at the second site 30. This allows the procedure person to perform the procedure by own terminal, and allows correctly dealing with, for example, the points to be checked and the surrounding situations related to the request and the procedure of product purchase.

(Fourth Modification of Operation of Procedure Sharing System 100)

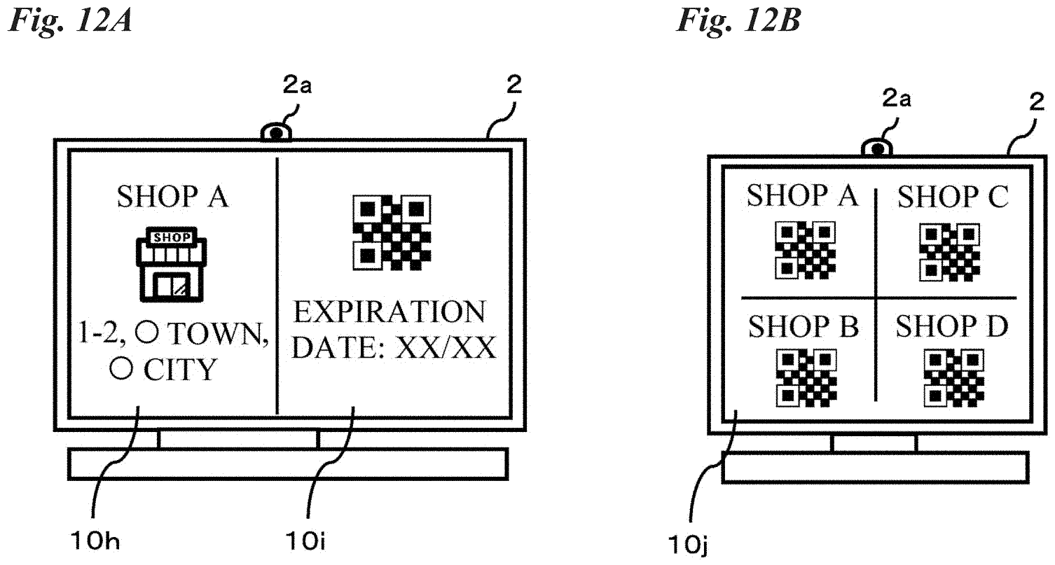

Next, regarding the first modification to a third modification of the procedure sharing system 100 in one embodiment, the fourth modification of the operation of the procedure sharing system will be described with reference to FIG. 12A and FIG. 12B.

A difference between the example of the operation described above and the first modification to the fourth modification is that, in FIG. 6A, for example, the management database in the management server 5 stores the shop name, the shop appearance, and the shop address corresponding to the procedure information 10i, and the procedure information 10h is displayed together with the procedure information 10i on the second terminal 2. This allows confirming, for example, detailed information and an expiration date regarding the procedure information 10i that cannot be found from only the video information.

At the video information acquiring means S100, for example, the video information (such as a OR code for product sale at a shop A) at the first site 20 is acquired via the camera in the first terminal 1.

At video information delivering means S110, the video information acquired at the video information acquiring means S100 is delivered to the second terminal 2 at the second site 30 in real time.

At the procedure information acquiring means S120, for example, the procedure information 10a of the shop A included in the video information at the second site 30 is acquired. The manager of the shop A at the first site 20, for example, may preliminarily register information of own shop (such as the procedure information 10h and the procedure information 10i) with the management database 6a in the management server 5.

At the procedure information displaying means S130, for example, the procedure information 10a acquired at the procedure information acquiring means S120 is displayed as the procedure information 10h or 10i on which the procedure can be performed by the second terminal 2 via the second terminal 2 at the second site 30. The procedure information 10h is, for example, information regarding the shop, and the procedure information 10i is, for example, term information regarding the expiration date of the preliminarily displayed procedure information 10a. At the procedure information displaying means S130, when another related information (such as information unique to the spot) is present, it may be displayed together. This allows the procedure person at the second site 3 to, for example, share the desired procedure through the on-site video information acquired by the first terminal 1 at the first site 20. This allows sharing the procedure between the respective sites by the terminals between the remote sites in real time. The procedure that the procedure person desires to perform can be shared while the on-site video is confirmed. Accordingly, for example, the procedure person can perform the correct procedure while confirming, for example, points to be checked and the periphery and circumference situations related to the request and the procedure of product purchase.

The difference between the example of the operation described above and the first modification to the fourth modification is that, in FIG. 6A, for example, at the procedure information acquiring means S120, the procedure information of the respective shops displayed in the plurality of shops (the shop A to the shop D) included in the acquired video information can be acquired. At the procedure information displaying means S130, a plurality of pieces of the procedure information 10a acquired at the procedure information acquiring means S120 are displayed on the second terminal 2 at the second site as the plurality of pieces procedure information 10a at the first site 20. This allows collectively confirming the procedure information 10a regarding the common procedure and making a payment.

At the video information acquiring means S100, for example, the video information (such as a shopping mall in which a plurality of shops are open) at the first site 20 is acquired via, the camera in the first terminal 1.

At the video information delivering means S110, the video information acquired at the video information acquiring means S100 is delivered to the second terminal 2 at the second site 30 in real time.

At the procedure information acquiring means S120, for example, when there is the procedure information of the plurality of shops (the shop A to the shop D) included in the video information at the first site 20, the procedure information is acquired in sequence.

At the procedure information displaying means S130, for example, a plurality of pieces of the procedure information 10a acquired at the procedure information acquiring means S120 are displayed as the procedure information 11j and as the procedure information 10j on which the procedure can be performed in the second terminal 2 via the first terminal 1 at the first site 20. The procedure information 10j is, for example, the QR code regarding the plurality of shops (such as the shop A to the shop D) and may be displayed on the second terminal 2 together based on the location information of each shop, the identification information identifying the shop, and information regarding the procedure information regarding the procedure of the shop. Accordingly, the procedure person at the second site 3, for example, can view the plurality of procedures acquired by the first terminal 1 at the first site 20 and can collectively perform the procedures.

According to this embodiment, the procedure sharing system 100 may perform the procedure information performing means S140 by the second terminal 2 at the second site 30. The procedure information performing means S140, for example, hands over the procedure information 10a displayed at the procedure information displaying means S130 to the application provided in the second terminal 2. The application to which the procedure information 10a has been handed over, for example, performs the procedure information 10a that has been handed over as a procedure by the second terminal 2 in the application.

At the procedure information performing means S140, for example, the procedure information 10a displayed at the procedure information displaying means S130 is captured or paused on the second terminal 2, and the displayed procedure information 10c is temporarily stored in the storage unit 104 in the second terminal 2. An application provided in the second terminal 2, for example, may be selected by the procedure person, and the selected application acquires the procedure information 10a stored in the storage unit 104.

The selected application deploys the acquired procedure information 10a and performs the procedure by the second terminal 2. Thus, without requiring the third terminal 3, based on the procedure information 10a displayed at the procedure information displaying means S130, the procedure at the first site can be performed as the procedure by the second terminal at the second site 30.

For example, as described above, as the second terminal 2, in addition to an electronic device, such as a mobile phone (a mobile terminal), a smart phone, a tablet terminal, a wearable device, a personal computer, and an IoT device, one that is embodied by any electronic device may be used. This allows direct procedure from the second terminal 2 at the second site 2, and the procedure of the procedure information 10a shared between the first site 20 and the second site 30 can be efficiently performed.

According to this embodiment, at the procedure information acquiring means S120, when the video information delivered at the video information delivering means S110 includes the procedure information 10c, the procedure information 10a, for example, may be acquired as a still image by a pause by the executer, the requester, or the procedure person input via the first terminal 1. In this case, the procedure information 10c is acquired as the still image from the video information. This allows acquiring the procedure information 10a without a blur at the first site 20.

At the procedure information displaying means S130, the procedure information 10c acquired at the procedure information acquiring means S120, for example, is displayed in the state where the procedure can be shared on the second terminal 2 as the procedure information 10a of the still image at the first site based on the location information and the identification information.

According to this embodiment, at the procedure information acquiring means S120, when the video information delivered at the video information delivering means S110 includes the procedure information 10c, the procedure information 10a, for example, may be acquired as a still image by a pause by the executer, the requestor, or the procedure person input via the first terminal 1. In this case, the first terminal 1 of the executer at the first site 20 is preliminarily connected to the second terminal 2 of the requestor or the third terminal 3 of the procedure person at the second site in real time to ensure performing an operation instruction from the second terminal 2 or the third terminal 3 to the first terminal 1. The first terminal 1 may be able to acquire the procedure information 10a according to the instructions and pause the video information.

This allows each of the requestor and the procedure person at the second site 30 to acquire the video information or acquire the procedure information 10a via the first terminal 1 at the first site 20 via the second terminal 2 or the third terminal 3. This allows sharing the procedure between the respective sites by the terminals between the remote sites in real time. The procedure that the procedure person desires to perform can be shared while the on-site video is confirmed. Accordingly, for example, the procedure person can perform the correct procedure while confirming, for example, points to be checked and the periphery and circumference situations related to the request and the procedure of product purchase.

Additionally, according to this embodiment, at the procedure information displaying means S130, the procedure information 10a acquired at the procedure information acquiring means S120 may be acquired as the still image, and may be displayed in the state where the procedure can be shared on the second terminal. At the procedure information displaying means S130, for example, the procedure information 10a, may be acquired as the still image from the delivered video information by the pause by the requester or the procedure person input via the second terminal 2. This allows acquiring the procedure information 10a without a blur at the second site 30.

According to this embodiment, the procedure information 10a, for example, in addition to the QR code, may be, for example, a barcode, JAN code, a membership card (for example, a QR code displayed as an electron medium), an entry card, a reward card, and a stamp card, and the procedure is performed according to the procedure information 10a displayed in each of the first site 20 and the second site 30. The information regarding the procedure information 10a is, for example, preliminarily registered with the management database 6a and the procedure sharing database 6b in the management server 5, and at each procedure, the procedure sharing system 100 appropriately refers to the information and each means is performed.

According to this embodiment, the second terminal 2, the third terminal 3, or the terminal at each shop, for example, may store a plurality of pieces of the procedure information 10a. The second terminal 2, the third terminal 3, or the terminal at each shop may appropriately select which one is used as the procedure information 10a by, for example, information, such as the product on which the procedure is performed, the amount of money, and a transaction history, and the contents of procedure (such as “payment,” “reservation,” and “vicarious execution”). Thus, the procedure can be shared between the first site 20 and the second site 30 according to, for example, the other party that performs the procedure at the first site 20, the target (content or a service) on which the procedure is performed at the first site 20, a condition and a limitation of the procedure, and the actual procedure at the second site 30, ensuring the appropriate procedure process in the procedure to be shared.

According to this embodiment, at the procedure information acquiring means S120, the procedure information 10a acquired at the video information acquiring means S100 or the procedure information 10a delivered at the video information delivering means S110 may be acquired by plural at time difference. The procedure information acquiring means S120, for example, acquires the procedure information 10a four times in one second (four pieces of the procedure information 10c haying the same contents), and the plurality of pieces of acquired procedure information 10a are displayed in the second terminal 2 (not illustrated). Thus, for example, at the procedure information acquiring means S120, when the unclear procedure information 10a is acquired (for example, a point where radio wave interference is large, a time slot during which an antenna level is low, a decrease in function of the terminal in use, and deterioration of a radio wave state), displaying another same procedure information 10a allows performing the correct procedure.

According to this embodiment, at the procedure information displaying means S130, as another display format illustrated in FIG. 12B, for example, a plurality of the same pieces of procedure information 10a acquired at the procedure information acquiring means S120 is acquired as the procedure information 10a at the first site 20 with timing, time, and an interval of acquisition changed, and the plurality of pieces of procedure information 10a are displayed as the procedure information 10a at the first site 20 in the state where the procedure can be shared on the second terminal (not illustrated). Thus, for example, at the procedure information acquiring means S120, even when the unclear procedure information 10a, is acquired, the plurality of pieces of procedure information 10a of the same contents are displayed, thereby ensuring the correct procedure.

Additionally, according to this embodiment, the procedure sharing method in which the procedure sharing system 100 is provided can be provided by; the video information acquiring means S100 that acquires the video information at the first site 20 including the location information at the first site 20, the identification information identifying the first site 20, and the procedure information 10a regarding the procedure at the first site 20 between the first terminal 1 at the first site 20 and the second terminal 2 at the second site 30 preliminarily connected to the first terminal 1 among the plurality of sites; the video information delivering means S110 that delivers the video information acquired by the video information acquiring means S100 to the second terminal 2 at the second site 30 in real time; the procedure information acquiring means S120 the acquires the procedure information 10 when the video information delivered by the video information acquiring means S110 includes the procedure information 10a; and the procedure information displaying means S130 that displays the procedure information 10a acquired by the procedure information acquiring means S120 in the state where the procedure can be shared on the second terminal 3 as the procedure information 10a at the first site 20 based on the location information and the identification information as the procedure information 10a at the first site 20.

While the embodiments of the present invention have been described, these embodiments have been presented by way of example, and are not intended to limit the scope of the invention. The novel embodiments described herein can be embodied in a variety of other configurations, and various omissions, substitutions, and changes can be made without departing from the gist of the invention. The accompanying claims and their equivalents cover such embodiments and modifications as would fall within the scope and the gist of the invention.

### DESCRIPTION OF REFERENCE SIGNS

1: First terminal
2: Second terminal
2a: Camera
3: Third terminal
4, 4a, 4b, 4c, 4d: Object
5: Management server
6a: Management database
6b: Procedure sharing database
7: Communication network
10a, 10b, 10c, 10d, 10e, 10f, 10g, 10h, 10i, 10j, 11a, 11b: Procedure information
11: Reception unit
12: Procedure terminal identification unit
13: Video information acquisition unit
14: Video information delivery unit
15: Procedure information acquisition unit
16: Procedure information display unit
17: Procedure information execution unit
18: Memory
19: Output unit
40: Housing
100: Procedure sharing system
101: CPU
102: ROM
103: RAM
104: Storage unit
105: I/F
106: I/F
107: I/F
108: Input part
109: Output part
110: internal bus
S100: Video information acquiring means step
S110: Video information delivering means step
S120: Procedure information acquiring means step
S130: Procedure information displaying means step
S140: Procedure information execution means step

1. A procedure sharing system in which terminals at a plurality of sites are communicatively connected over a network to share procedures between the respective sites, the procedure sharing system comprising:
video information acquiring means that acquires video information at a first site including location information at the first site, identification information identifying the first site, and procedure information regarding the procedure at the first site based on request information regarding photographing at the first site input via a second terminal at a second site via a first terminal between the first terminal at the first site and the second terminal at the second site preliminarily connected to the first terminal among the plurality of sites;
video information delivering means that delivers the video information acquired by the video information acquiring means to the second terminal at the second site in real time;
procedure information acquiring means that acquires the procedure information based on instruction information regarding the photographing of the procedure information input via the second terminal at the second site via the first terminal when the video information delivered by the video information delivering means includes the procedure information; and
procedure information displaying means that displays the procedure information acquired by the procedure information acquiring means in a state where the procedure is allowed to be shared on the second terminal based on the location information, the identification information, and a display restriction at the second site or in the second terminal related to the procedure information.

2. The procedure sharing system according to claim 1, further comprising:
a third terminal at the second site; and
procedure information performing means that acquires the procedure information displayed by the procedure information displaying means via the third terminal, discriminates a procedure performable by the third terminal at the second site based on the acquired procedure information, and performs the procedure information via the third terminal by the discriminated procedure.

3. The procedure sharing system according to claim 1, wherein
the procedure information acquired by the video information acquiring means is displayed by non-disclosure, disclosure, or alternative display in the first terminal or the second terminal, and the procedure information includes at least any information of object information identifying an object at the first site, procedure person information identifying a procedure person who performs the procedure, procedure location information identifying a procedure place, a procedure period information regarding a valid period of the procedure, and payment information regarding a payment for the procedure.

4. The procedure sharing system according to claim 1, wherein
when the procedure information acquiring means acquires the procedure information included in the video information via the first terminal, the procedure information acquiring means acquires the procedure information as a still image such that the procedure information is not deployed in the first terminal or the second terminal.

3. The procedure sharing system according to claim 3, wherein
the procedure information displaying means allows displaying the procedure information delivered by the video information delivering means by non-disclosure, disclosure, or alternative display in the first terminal or the second terminal, and when a plurality of pieces of the procedure information are present, the plurality of pieces of procedure information are displayed in a state where the procedure is allowed to be shared on the second terminal as the procedure information at the first site based on at least any information of the object information, the procedure person information, the procedure location information, the procedure period information, and the payment information included in the procedure information.

6. A procedure sharing method in which terminals at a plurality of sites are communicatively connected over a network to share procedures between the respective sites, the procedure sharing method executed by a computer comprising:
a video information acquiring step of acquiring video information at a first site including location information at the first site, identification information identifying the first site, and procedure information regarding the procedure at the first site based on request information regarding photographing at the first site input via a second terminal at a second site via a first terminal between the first terminal at the first site and the second terminal at the second site preliminarily connected to the first terminal among the plurality of sites;
a video information delivering step of delivering the video information acquired at the video information acquiring step to the second terminal at the second site in real time;
a procedure information acquiring step of acquiring the procedure information based on instruction information regarding the photographing of the procedure information input via the second terminal at the second site via the first terminal when the video information delivered at the video information delivering step includes the procedure information; and
a procedure information displaying step of displaying the procedure information acquired at the procedure information acquiring step in a state where the procedure is allowed to be shared on the second terminal based on the location information, the identification information, and a display restriction at the second site or in the second terminal related to the procedure information.

7. The procedure sharing method according to claim 6, wherein
on the third terminal at the second site, the computer performs a procedure information performing step of acquiring the procedure information displayed at the procedure information displaying step via the third terminal, the procedure information performing step of discriminating a procedure performable by the third terminal at the second site based on the acquired procedure information, the procedure information performing step of performing the procedure information via the third terminal by the discriminated procedure.
